(19) United States
(12) Patent Application Publication
(10) Pub. No.: US 2013/0077886 A1
(43) Pub. Date: Mar. 28, 2013

(54) IMAGE DECODING APPARATUS, IMAGE CODING APPARATUS, IMAGE DECODING METHOD, IMAGE CODING METHOD, AND PROGRAM

(71) Applicant: Kenji Kondo, Tokyo (JP)

(72) Inventor: Kenji Kondo, Tokyo (JP)

(73) Assignee: SONY CORPORATION, Tokyo (JP)

(21) Appl. No.: 13/701,318

(22) PCT Filed: May 25, 2011
(86) PCT No.: PCT/JP2011/061973

§ 371 Date: Nov. 30, 2012

(30) Foreign Application Priority Data
Jun. 7, 2010 (JP) 2010-130287

(51) Int. Cl. G06T 9/00

(52) U.S. Cl. CPC G06T 9/004
USPC 382/238

(57) ABSTRACT

The present invention relates to implementation of efficient decoding and coding of an image. A plurality of variable length decoding units 52 performs variable length decoding on a coded stream according to each different layer. The variable length decoding corresponds to variable length coding. The selecting unit 522 selects an output from the variable length decoding unit that corresponds to the layer including the block to be decoded based on the hierarchical structure information included in the stream and indicating the layer including the block to be decoded. The predictive motion vector setting unit 523 sets the motion vector of a block on a higher layer as the predictive motion vector. The block on a higher layer includes the block to be decoded and has a block size larger than that of the block to be decoded. The addition unit 525 adds the set predictive motion vector to the selected difference motion vector output from the variable length decoding unit in order to calculate the motion vector of the block to be decoded.

### TECHNICAL FIELD

The present invention relates to an image decoding apparatus, an image coding apparatus, an image decoding method, an image coding method, and a program. In particular, there is provided an image decoding apparatus, an image coding apparatus, an image decoding method, an image coding method, and a program that can efficiently decode or code an image.

### BACKGROUND ART

An apparatus in compliance with a scheme such as MPEG has recently become widespread for data distribution by a broadcasting station or the like and data reception at home. In such a scheme, image information is treated as digital, and then is compressed by an orthogonal transform such as a discrete cosine transform and a motion compensation using the redundancy peculiar to the image information in order to transmit and store information with efficiency.

Especially, MPEG 2 (ISO/IEC 13818-2) is defined as a general-purpose image coding scheme. MPEG 2 is a standard that covers both an interlaced scanning image and a progressive scanning image, and a standard-resolution image and a high-definition image. MPEG 2 is widely used for board applications for professionals and for consumers at present. Using an MPEG 2 compression scheme, for example, allotting the number of bits (bit rate) of 4 to 8 Mbps to a standard-resolution interlaced scanning image having 720×480 pixels can implement a high compression rate and a high image quality. Further, for example, allotting the number of bits of 18 to 22 Mbps to a high-definition interlaced scanning image having 1920×1088 pixels can implement a high compression rate and a high image quality.

MPEG 2 is mainly intended for coding a high-quality image suitable for broadcasting and MPEG 2 does not accept the lower number of bits (bit rate) than those of MPEG 1 or, namely, a coding scheme having a higher compression rate. It has been expected that there would be a growing needs for such a coding scheme future because of the popularization of mobile terminals. In response to the needs, MPEG 4 coding scheme has been standardized. The specification of the scheme has been authorized as the international standard ISO/IEC 14496-2 in December, 1998.

Further, although more computation for code and decode is required in comparison with those of the coding schemes such as MPEG 2 and MPEG 4, a higher efficiency of code implemented these days. For example, standardization has been conducted and has become an international standard, called H.264 and MPEG-4 Part 10 (Advanced Video Coding, hereinafter referred to as H.264/AVC). The standardization is based on H.26L and also incorporates functions that are not supported by H.26L in order to implement the higher efficiency of coding.

Further, for example, Patent Document 1 discloses a more efficient image data coding using the H.264/AVC.

### CITATION LIST

### Patent Document

Patent Document 1: Japanese Patent Application Laid-Open No. 2008-4984

### SUMMARY OF THE INVENTION

### Problems to be Solved by the Invention

By the way, although the method in the past attempts to implement a high efficiency of coding, it is desirable to improve the efficiency of coding in order to enable a higher efficiency.

In light of the foregoing, an objective of the present invention is to provide an image decoding apparatus, an image coding apparatus, an image decoding method, an image coding method, and a program that can efficiently decode and encode an image.

### Solutions to Problems

A first aspect of the present invention is an image decoding apparatus including: a variable length decoding unit for decoding a coded stream to output a difference motion vector; a predictive motion vector setting unit for setting a motion vector of a block on a higher layer as a predictive motion vector of a block to be decoded, the block at the higher layer including the block to be decoded and having a block size larger than a block size of the block to be decoded; and an addition unit for adding the difference motion vector to the predictive motion vector to calculate the motion vector of the block to be decoded.

According to the present invention, a plurality of variable length decoding units performs a variable length decoding on a coded stream according to each different layer. The variable length decoding corresponds to a variable length coding. An output from the variable length decoding unit that corresponds to the layer including the block to be decoded is selected based on the hierarchical structure information included in the stream and indicating the layer including the block to be decoded. The motion vector of a block on a higher layer is set as the predictive motion vector. The block on a higher layer includes the block to be decoded and has a block size larger than that of the block to be decoded. The set predictive motion vector is added to the selected difference motion vector output from the variable length decoding unit in order to calculate the motion vector of the block to be decoded.

A second aspect of the present invention is an image decoding method including: a variable length decoding step for decoding a coded stream to output a difference motion vector; a predictive motion vector setting step for setting a motion vector of a block on a higher layer as a predictive motion vector of a block to be decoded, the block at the higher layer including the block to be decoded and having a block size larger than a block size of the block to be decoded; and an addition step for adding the difference motion vector to the predictive motion vector to calculate the motion vector of the block to be decoded.

A third aspect of the present invention is a program for causing a computer to execute image coding and for causing the computer to execute: a variable length decoding procedure for decoding a coded stream to output a difference motion vector; a predictive motion vector setting procedure for setting a motion vector of a block on a higher layer as a predictive motion vector of a block to be decoded, the block at the higher layer including the block to be decoded and having a block size larger than a block size of the block to be decoded; and an addition procedure for adding the difference motion vector to the predictive motion vector to calculate the motion vector of the block to be decoded.

A fourth aspect of the present invention is an image coding apparatus including: a predictive motion vector setting unit for setting a motion vector detected at a block on a higher layer as a predictive motion vector of a block to be coded, the block at the higher layer including the block to be coded and having a block size larger than a block size of the block to be cooled; a difference calculation unit for calculating a difference between the motion vector of the block to be coded and the set predictive motion vector; and a variable length coding unit for performing variable length coding of the difference motion vector.

According to the present invention, the motion vector detected at a block on a higher layer is set as the predictive motion vector of the block to be coded. The block on a higher layer includes the block to be coded and has a block size larger than that of the block to be coded. Further, a difference motion vector is generated. The difference motion vector indicates the difference between the motion vector of the block to be coded and the set predictive motion vector. The difference motion vector is coded in a plurality of variable length coding units for performing a variable length coding that has been optimized, in order to cause the most efficient coding at each different layer. Then, the output from the variable length coding unit that corresponds to the layer including the block to be coded is selected and included in the coded stream. Hierarchical structure information is generated at each, macroblock having a block size of the highest layer and is included in the coded stream. The hierarchical structure information indicates the layer including the block to be encoded included in the macroblock. Further, the motion vectors of the coded adjoining macroblocks are set as the candidates of the predictive motion vector. The motion vector causing the most efficient coding is set as the predictive motion vector of the highest layer from among the candidates.

A fifth aspect of the present invention, is an image coding method including: a predictive motion vector setting step for setting a motion vector detected at a block on a higher layer as a predictive motion vector of a block to be coded, the block at the higher layer including the block to be coded and having a block size larger than a block size of the block to be coded; a difference calculation step for calculating a difference between the motion vector of the block to be coded and the set predictive motion vector; and a variable length coding step for coding the difference motion vector.

A sixth aspect of the present invention is a program for causing a computer to execute image coding and for causing the computer to execute; a predictive motion vector setting procedure for setting a motion vector detected at a block on a higher layer as a predictive motion vector of a block to be coded, the block at the higher layer including the block to be coded and having a block size larger than a block size of the block to be coded; a difference calculation procedure for calculating a difference between the motion vector of the block to be coded and the set predictive motion vector; and a variable length coding procedure for coding the difference motion, vector.

A seventh aspect of the present invention is an image coding apparatus including: a multi-resolution analysis/restructuring unit for performing a multi-resolution analysis on an image of a block to be coded and restructuring the image; a multi-resolution analysis unit for performing a multi-resolution analysis on a reference image used for calculating the motion vector; a memory for storing a result from, the multi-resolution analysis on the reference image; a multi-resolution restructuring unit for restructuring an image using the result from the multi-resolution analysis stored in the memory; and a motion prediction unit for roughly detecting a motion vector using a low-resolution image to be coded and a low-resolution reference image, and accurately detecting the motion vector using a high-resolution image to be coded and a high-resolution selective reference image, the low-resolution image to be coded being generated in the multi-resolution analysis/restructuring unit, the low-resolution reference image being generated in the multi-resolution restructuring unit, the high-resolution image to be coded being generated in the multi-resolution analysis/restructuring unit, the high-resolution selective reference image being in a selected region set based on the roughly-detected motion vector, the high-resolution selective reference image being generated in the multi-resolution restructuring unit.

According to the present invention, a multi-resolution analysis is performed on an image of the block to be coded and the image is restructured. A multi-resolution analysis is further performed on a reference image used for calculating a motion vector. The result from the multi-resolution analysis of the reference image is stored in a first memory in the order of resolution from lowest to highest. The multi-resolution analysis result exceeding the memory capacity of the first memory is stored in a second memory. The image is restructured using the multi-resolution analysis result stored in the first memory. As for the detection of a motion vector, a motion vector is roughly detected using a low-resolution image to be coded and a low-resolution reference image. The low-resolution image to be coded has been generated by a multi-resolution analysis of the image including the block to be coded and the restructuring of the image. The low-resolution reference image has been restructured using the multi-resolution analysis result stored in the first memory. Further, the motion vector is accurately detected using a high-resolution image to be coded and a high-resolution selective reference image in the selected region that has been set based on the roughly-detected motion vector. When a multi-resolution analysis result necessary to restructure the image is not stored in the first memory, the necessary multi-resolution analysis result is read from the second memory in order to generate the high-resolution selective reference image.

An eighth aspect of the present invention is an image coding method including: a multi-resolution analysis/restructuring step for performing a multi-resolution analysis and restructuring on an image of a block to be coded; a multi-resolution analysis step for performing a multi-resolution analysis on a reference image used for calculating the motion vector; a storing step for storing a result from the multi-resolution analysis in a memory; a multi-resolution restructuring step for restructuring an image using the result from the multi-resolution analysis stored in the memory; and a motion prediction step for roughly detecting a motion vector using a low-resolution image to be coded and a low-resolution reference image, and accurately detecting the motion vector using a high-resolution image to be coded and a high-resolution selective reference image, the low-resolution image to be coded being generated, in the multi-resolution analysis/restructuring unit, the low-resolution reference image being generated in the multi-resolution restructuring unit, the high-resolution image to be coded being generated in the multi-resolution analysis/restructuring unit, the high-resolution selective reference image being in a selected region set based on the roughly-detected motion vector and being generated in the multi-resolution restructuring unit.

A ninth aspect of the present invention is a program for causing a computer to execute image coding and for causing the computer to execute: a multi-resolution analysis/restructuring procedure for performing a multi-resolution analysis and restructuring on an image of a block to be coded; a multi-resolution analysis procedure for performing a multi-resolution analysis on a reference image used for calculating the motion vector; a storing procedure for storing a result from the multi-resolution analysis in a memory; a multi-resolution restructuring procedure for restructuring an image using the result from the multi-resolution analysis stored in the memory; and a motion prediction procedure for roughly detecting a motion vector using a low-resolution image to be coded and a low-resolution reference image, and accurately detecting the motion vector using a high-resolution image to be coded and a high-resolution selective reference image, the low-resolution image to be coded being generated in the multi-resolution analysis/restructuring unit, the low-resolution reference image being generated in the multi-resolution restructuring unit, the high-resolution image to be coded being generated in the multi-resolution analysis/restructuring unit, the high-resolution selective reference image being in a selected region set based on the roughly-detected motion vector and being generated in the multi-resolution restructuring unit.

Note that, for example, the program according to the present invention can be provided by a storage medium and a that provide a program in a computer-readable format to a general-purpose computer system capable of executing various program codes. The storage medium includes an optical disc, a magnetic disc, or a semiconductor memory. The communication medium includes a network. Providing such a program in a computer-readable format can implement a process according to the program on a computer system.

### Effects of the Invention

According to the present invention, decoding a coded stream generates a difference motion vector. Further, the motion vector of a block on a higher layer is set as the predictive motion vector. The block on a higher layer includes the block to be decoded and has a block size larger than that of the block to be decoded. The generated difference motion vector is added to the set predictive motion vector in order to calculate the motion vector of the block to be decoded. Further, the motion vector detected at a block on a higher layer is set as the predictive motion vector of the block to be coded. The block on a higher layer includes the block to be coded and has a block size larger than that of the block to be coded. A variable length coding is performed on the difference motion vector than indicates the difference between the motion vector of the block to be coded and the set predictive motion vector. The improvement of the prediction accuracy using the motion vector on a higher layer as the predictive motion vector in such a manner can efficiently code and decode an image.

Further, a multi-resolution analysis is performed on an image of the block to be coded and the image is restructured. A multi-resolution analysis is further performed on a reference image. The result from the multi-resolution analysis on the reference image is stored in a memory. The image is restructured using the multi-resolution analysis result stored in the memory. In the detection of a motion vector, the motion vector is roughly detected using a low-resolution image to be coded and a low-resolution reference image. The low-resolution image to be coded has been generated by a multi-resolution analysis of the image including the block to be coded and the restructuring of the image. The low-resolution reference image has been restructured using the multi-resolution analysis result stored in the memory. Further, the motion vector is accurately detected using a high-resolution image to be coded and a high-resolution selective reference image in the selected region that has been set based on the roughly-detected motion vector. In such a manner, a motion vector is roughly detected using a low-resolution image, and then the motion vector is accurately detected using a high-resolution image to be coded and a high-resolution selective reference image in the selected region that has been set the rough detection result. Thus, the data amount read from, the memory can be small in order to detect the motion vector, and the motion vector can efficiently be detected. This can efficiently code an image.

### BRIEF DESCRIPTION OF DRAWINGS

FIG. 1 is a view for describing a conventional method for setting a predictive vector.

FIG. 2 is a view for showing the structure of an image coding apparatus.

FIG. 3 is a view for showing the structure relating to a motion vector in a lossless coding unit.

FIG. 4 is a view for showing an exemplary relationship between the length of a difference motion vector and the probabilistic density.

FIG. 5 is a view for showing prediction block sizes used for the image coding process.

FIG. 6 is a flowchart for showing the operations of an image coding process.

FIG. 7 is a flowchart for showing a prediction process.

FIG. 8 is a flowchart for showing an intra prediction process.

FIG. 9 is a flowchart for showing an inter prediction process.

FIG. 10 is a flowchart for showing a coding process relating to a motion vector in the lossless coding unit.

FIG. 11 is a view for showing exemplary operations when the coding process relating to the motion vectors is performed.

FIG. 12 is a view for describing hierarchical structure information.

FIG. 13 is a view for showing the structure of an image decoding apparatus.

FIG. 14 is a view for showing the structure relating to a motion vector in a lossless decoding unit.

FIG. 15 is a flowchart for showing the operations of an image decoding process.

FIG. 16 is a flowchart for showing a decoding process relating to a motion vector in the lossless decoding unit.

FIG. 17 is a flowchart for showing a prediction process.

FIG. 18 is a view for showing another structure of the image coding apparatus.

FIG. 19 is a view for describing the one dimensional sub-band decomposition.

FIG. 20 is a view for showing an exemplary result from the sub-band decomposition when a two dimensional decomposition is performed.

FIG. 21 is a flowchart for showing the operations for detecting a motion vector.

FIG. 22 is an exemplary view for showing a schematic structure of a television apparatus.

FIG. 23 is an exemplary view for showing a schematic structure of a mobile phone.

FIG. 24 is an exemplary view for showing a schematic structure of a record and replay apparatus.

FIG. 25 is an exemplary view for showing a schematic structure of an imaging apparatus.

### MODE FOR CARRYING OUT THE INVENTION

Embodiments of the present invention will be described below. Note that the description will be provided in the following order.

1. Structure of image coding apparatus

2. Structure of lossless coding unit

3. Operations of image coding apparatus

4. Structure of image decoding apparatus

5. Structure of lossless decoding unit

6. Operations of image decoding apparatus

7. Another structure of image coding apparatus

8. Operations for detecting motion vector

9. Process with software

10. Application to electronic device

### <1. Structure of Image Coding Apparatus>

During coding of image data, to reduce the number of bits, the difference between the motion vector of a block to be cooled and the predictive motion vector is found and the difference motion vector is coded and included in the stream. In that case, if the median value (median) of the adjoining blocks is uses as the predictive motion vector as in the H.264/AVC scheme, the median value is not always the optimal predictive motion vector.

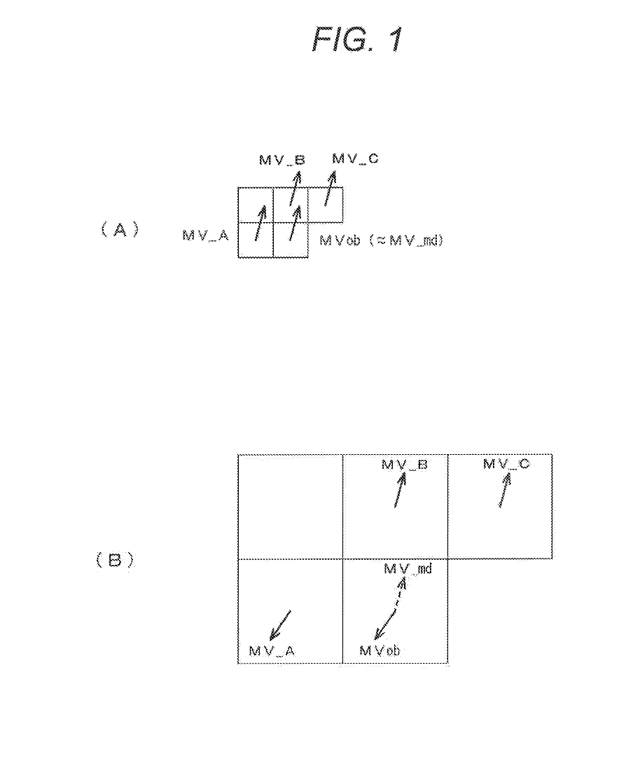

FIG. 1 is a view for describing a conventional method for setting a predictive vector. For example, as shown in FIG. 1(A), when the a prediction block size (motion compensation block size) is small, the motion vectors of the adjoining blocks MV_A, MV_B, and MV_C are the motion vectors of the regions adjacent to the block to be coded. Thus, the prediction accuracy is high. In other words, the difference between the median value MV_md and the motion vector of the block to be coded MVob is small. However, as shown in FIG. 1(B), when the prediction block size is large, the adjoining blocks include regions away from the block to be coded. Thus, the difference between the median value MV_md and the motion vector of the block to be coded MVob can be large. This possibly reduces the prediction accuracy in comparison with the prediction accuracy in the case where the prediction block size is small.

The motion vector detected at a small size block (block on a lower layer) that is included in a block on an higher layer is often similar to the motion vector detected, at the large size block (block on the higher layer) because the block on the lower layer is included in the block on the higher layer.

In light of the foregoing, the image coding apparatus according to the present invention uses the motion vector detected at the block on a higher layer as the predictive motion vector so that the prediction accuracy can be improved and an image can efficiently be coded. The block on a higher layer includes the block to be coded and has a size larger than that of the block to be coded.

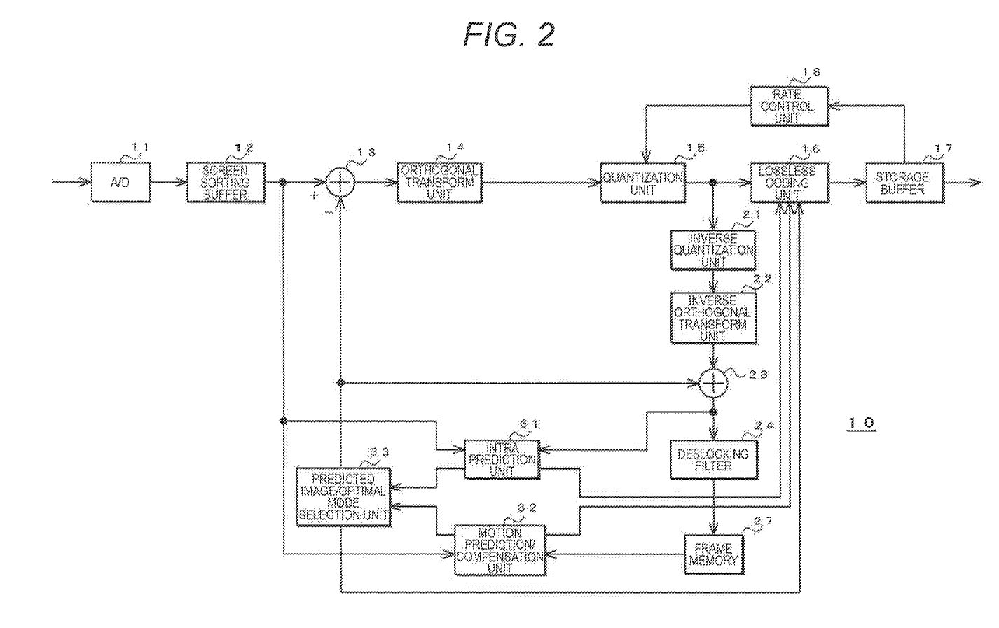

FIG. 2 is a view for showing the structure of an image coding apparatus. An image coding apparatus 10 includes an analog/digital converting unit (A/D converting unit) 11, a screen sorting buffer 12, a subtraction unit 13, an orthogonal transform, unit 14, a quantization unit 15, a lossless coding unit 16, an storage buffer 17, and a rate control unit 18. The image coding apparatus 10 further includes an inverse quantization unit 21, an inverse orthogonal transform unit 22, an addition unit 23, a deblocking filter 24, a frame memory 27, an intra prediction unit 31, a motion prediction/compensation unit 32, and a predicted image/optimal mode selection unit 33.

The A/D converting unit 11 converts an analog image signal into digital image data and outputs the data to the screen sorting buffer 12.

The screen sorting buffer 12 sorts the frames of the image data output from the A/D converting unit 11. The screen sorting buffer 12 sorts the frames according to the group of pictures (GOP) structure for a coding process in order to output the sorted image data to the subtraction unit 13, the intra prediction unit 31, and the motion prediction/compensation unit 32.

The subtraction unit 13 is supplied with the image data output from the screen sorting buffer 12 and a predicted image data selected in the predicted image/optimal mode selection unit 33 described below. The subtraction unit 13 calculates a predictive error data and outputs the data to the orthogonal transform unit 14. The predictive error data is the difference between the image data output from the screen sorting buffer 12 and the predicted image data supplied from the predicted, image/optimal mode selection unit 33.

The orthogonal transform unit 14 performs an orthogonal transform on the predictive error data output from the subtraction unit 13 using the discrete cosine transform (DCT) or the Karhunen-Loeve Transformation. The orthogonal, transform unit 14 outputs the conversion coefficient data obtained from the orthogonal transform process to the quantization unit 15.

The quantization unit 15 is supplied with the conversion coefficient, data output from the orthogonal transform, unit 14 and a rate control signal from the rate control unit 13 described below. The quantization unit 15 quantizes the conversion coefficient, data and outputs the quantized data to the lossless coding unit 16 and the inverse quantization unit 21. The quantization unit 15 further switches a quantization parameter (quantization scale) based on the rate control signal from the rate control unit 18 in order to change the bit rate of the quantized data.

The lossless coding unit 16 is supplied with the quantized data output from the quantization unit 15 and predictive mode information from the intra prediction unit 31, the motion prediction/compensation unit 32 and the predicted image/optimal mode selection unit 33 described below. Note that the predictive mode information includes, for example, a macroblock type indicating the prediction block size, a predictive mode, and reference picture information, depending on the intra prediction or the inter prediction. The lossless coding unit 16 codes the quantized data using the variable length coding, the arithmetic coding or the like in order to generate a coded stream and output the stream to the storage buffer 17. The lossless coding unit 16 further losslessly codes the predictive mode information in order to add the information, for example, to the header information in the coded stream. The lossless coding unit 16 further sets, as the predictive motion vector of the predictive block in the optimal mode that is the block of the image to be coded, the motion vector detected at a block on the next higher layer that includes the predictive block. The lossless coding unit 16 losslessly codes the difference motion vector indicating the difference between the predictive motion vector and the motion vector of the block to be coded in order to add the difference motion vector to the coded stream. The lossless coding unit 16 further sets a predictive motion vector at each of the predictive blocks in the calculation of the cost function value described below in order to losslessly code the difference motion vector indicating the difference from the motion vector of the predictive block so that the generated numbers of bits including the coded data of the difference motion vector can be calculated.

The storage buffer 17 stores the coded stream from the lossless coding unit 16. The storage buffer 17 further outputs the stored coded stream at a transmission rate according to the transmission channel.

The rate control unit 18 monitors the amount of space on the storage buffer 17 to generate a rate control signal according to the amount of space and output the signal to the quantization unit 15. The rate control unit 18, for example, obtains the information indicating the amount of space from the storage buffer 17. When one amount of space becomes small, the rate control unit 18 reduces the bit rate of the quantized data using the rate control signal. On the other hand, when the amount of space on the storage buffer 17 is large enough, the rate control unit 18 increases the bit rate of the quantized data using the rate control signal.

The inverse quantization unit 21 performs an inverse quantization process on the quantized data supplied from the quantization unit 15. The inverse quantization unit 21 outputs, to the inverse orthogonal transform unit 22, the conversion coefficient data obtained from the inverse quantization process.

The inverse orthogonal transform unit 22 outputs, to the addition unit 23, the data obtained from the inverse orthogonal transform process on the conversion coefficient data supplied from the inverse quantization unit 21.

The addition unit 23 generates reference image data by adding the data supplied from the inverse orthogonal transform unit 22 to the predicted image data supplied from the predicted image/optimal mode selection unit 33 in order to output the reference image data to the deblocking filter 24 and the intra prediction unit 31.

The deblocking filter 24 performs a filtering process for reducing the block distortion developed when an image is coded. The deblocking filter 24 performs the filtering process for eliminating the block distortion from the reference image data supplied from the addition, unit 23 in order to output the filtered reference image data to the frame memory 27.

The frame memory 27 maintains the filtered reference image data that has been supplied from the deblocking filter 24.

The intra prediction unit 31 performs an intra prediction, process on every candidate intra prediction mode using the image data of the image to be coded that has been output from the screen sorting buffer 12 and the reference image data supplied from the addition, unit 23. The intra prediction unit 31 further calculates the cost function value of each of the intra prediction modes in order to select, as the optimal intra prediction mode, the intra prediction mode that has the minimum calculated cost function value or, namely, the intra prediction mode causing the most efficient coding. The intra prediction unit 31 outputs, to the predicted image/optimal mode selection unit 33, the predicted image data generated in the optimal intra prediction mode, the prediction mode information about the optimal intra prediction mode, and the cost function value in the optimal intra prediction mode. The intra prediction unit 31 further outputs, to the lossless coding unit 16, the prediction mode information about the intra prediction mode during the intra prediction process in each of the intra prediction modes in order to obtain the generated number of bits used for calculating the cost function value as described below.

The motion prediction/compensation unit 32 performs a motion prediction and compensation processes using every prediction block size (motion compensation block size) that corresponds to a macroblock. Using the filtered reference image data read from the frame memory 27, the motion prediction/compensation unit 32 detects the motion vector of every image having each prediction block size that has been read from the screen, sorting buffer 12. The motion prediction/compensation unit 32 further performs a motion compensation on the reference image based on the detected motion vectors to generate a predicted image.

The motion prediction/compensation unit 32 further calculates the cost function value of each candidate of the predictive motion vector and notifies the value to the lossless coding unit 16. The motion prediction/compensation unit 32 selects the prediction block size having the minimum cost function value or, namely, the prediction block size causing the most efficient coding as the optimal inter prediction mode based, on the calculated cost function value of each of the prediction block sizes. The motion prediction/compensation unit 32 outputs, to the predicted image/optimal mode selection unit 33, a predicted image data generated in the optimal inter prediction mode, the prediction mode information about the optimal inter prediction mode, and the cost function value in the optimal inter prediction mode. The motion prediction/compensation unit 32 further outputs the prediction mode information about the inter prediction mode to the lossless coding unit 16 during the inter prediction process in each of the prediction block sizes in order to obtain, the generated numbers of bits that is used for the calculation of the cost function value. Note that the motion prediction/compensation unit 32 also predicts a skipped, macroblock or a direct mode as the inter prediction mode.

The predicted image/optimal mode selection unit 33 compares the cost function value supplied from the intra prediction unit 31 to the cost function value supplied from the motion prediction/compensation unit 32 by macroblock in order to select the smaller cost function value as the optimal mode causing the most efficient coding. The predicted image/optimal mode selection unit 33 further outputs a predicted image data generated in the optimal mode to the subtraction unit 13 and the addition unit 23. The predicted image/optimal mode selection unit 33 further outputs the prediction mode information about the optimal mode to the lossless coding unit 16. Note that the predicted image/optimal mode selection unit 33 performs the intra prediction or the inter prediction by slice.

### <2. Structure of Lossless Coding Unit>

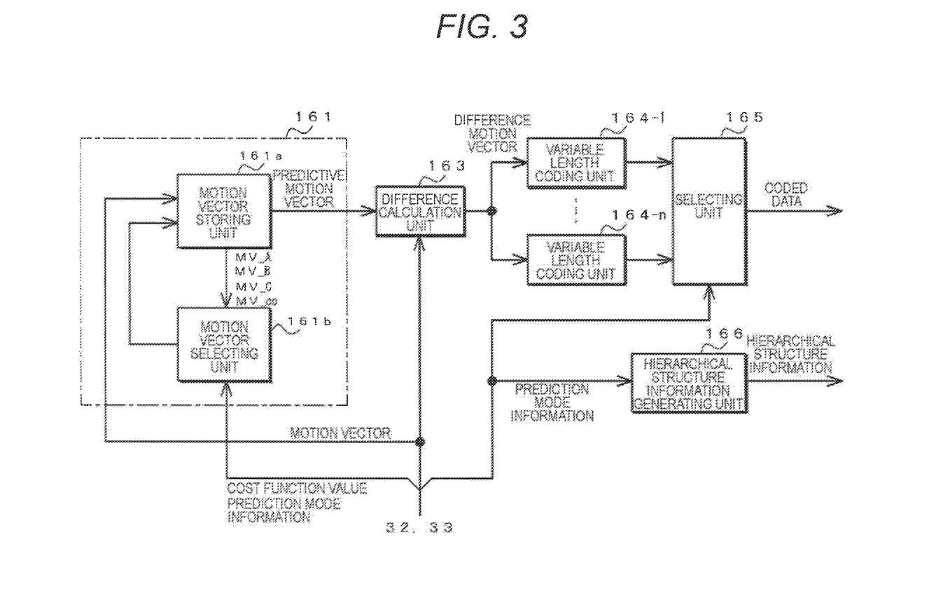

FIG. 3 shows the structure relating to a motion vector in a lossless coding unit. The lossless coding unit 15 includes a predictive motion vector setting unit 161, a difference calculation unit 163, variable length coding units 164-1 to 164-n, and a selecting unit 165. The predictive motion vector setting unit 161 includes a motion vector storing unit 161a and a motion vector selecting unit 161b.

On the highest layer having the largest prediction block size, the motion vector storing unit 161a stores, as the candidates of the predictive motion vector on the highest layer, the motion vectors of the coded blocks adjoining to the block to be coded (macroblock) when the prediction block has the largest size. Note that the motion vector storing unit 161a can also store the motion vector of the block in the reference picture chat is identical to the block to be coded in order to accept the direct mode. The motion vector storing unit 161a further stores the motion vector of the block on each layer supplied from the motion prediction/compensation unit 32.

The motion vector selecting unit 161b determines which layer has the prediction block in the optimal mode that is the block to be coded based on the prediction mode information about the optimal mode supplied from the predicted image/optimal mode selection unit 33. When the block to be coded is on the highest layer, the motion vector selecting unit 161b sets the predictive motion vector causing the most efficient coding from among the candidates of the predictive motion vector based on the cost function value supplied from the motion prediction/compensation unit 32. On the other hand, when the block to be coded is not on the highest layer, the motion vector selecting unit 161b sets, as the predictive motion vector, the motion vector detected at the block on a layer having the next larger size than the determined layer. The block also includes the block to be coded.

The difference calculation unit 163 calculates the difference motion vector between the motion vector of the block to be coded and the predictive motion vector set by the predictive motion vector setting unit 161.

The variable length coding units 164-1 to 164-n perform variable length coding on the difference motion vector calculated by the difference calculation unit 153. The variable length coding units 164-1 to 164-n perform the variable length coding optimized to cause the most efficient coding on the difference motion vector on each different layer.

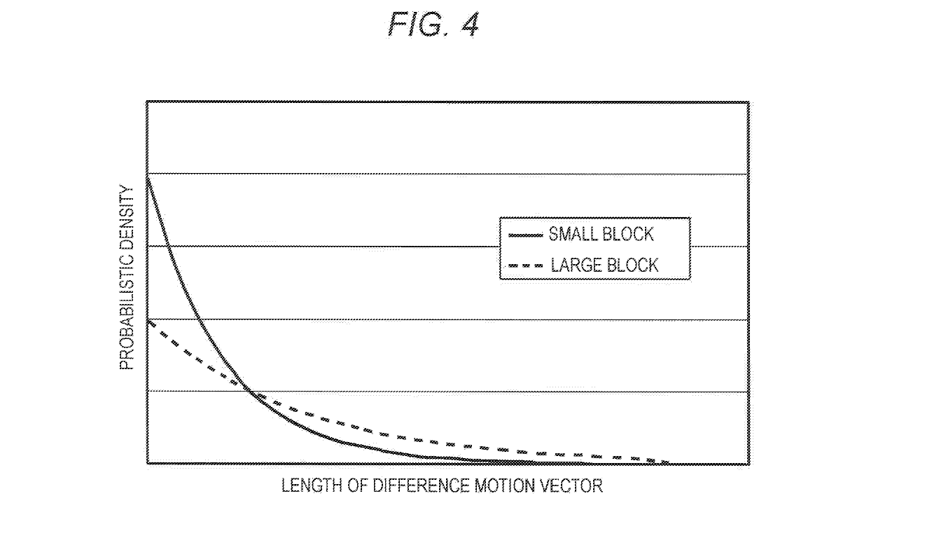

In this case, as described above with reference to FIG. 1, it is considered that the variation of the motion vectors is small when the block size is small in comparison with when the block size is large. Thus, as for the difference motion vector, a small block size has a higher probability of generations of the short difference motion vector than a large block size. In other words, the relationship between the length of the difference motion vector and the probabilistic density is shown, for example, in FIG. 4.

Thus, the variable length coding units 164-1 to 164-n allot the less number of bits when the length of the difference motion vector is short because the short difference motion vector has a high probability of generations in comparison with the variable length coding at a block size on a higher layer. For example, the variable length coding unit 164-1 performs a variable length coding using a VLC table that has been optimized to cause the most efficient coding for the highest layer, for example, a VLC table that has been optimized to cause the most efficient coding for the characteristic shown with the dished line in FIG. 4. Further, the variable length coding unit 164-n performs si variable length coding using a VLC table that has been optimized to cause the most efficient coding for the lowest layer, for example, a VLC table that has been optimized to cause the most efficient coding for the characteristic shown with the solid line in FIG. 4. As described, above, performing a variable length coding depending on the layer increases the efficiency of coding.

The selecting unit 165 selects the coded data corresponding to the prediction block size in the optimal mode from, among the coded data supplied from, the variable length coding units 164-1 to 164-n in order to add the coded data to the header information of the coded stream.

A hierarchical structure information generating unit 166 generates, at each macroblock that has the block size of the highest layer, the hierarchical structure information indicating the layer of the block to be coded included, in the macroblock based on the prediction block size in the optimal mode supplied from the predicted image/optimal, mode selection unit 33. The hierarchical structure information generating unit 166 adds the generated hierarchical structure information to the header information in the coded stream.

Further, although not shown the drawings, the lossless coding unit 16 adds the predictive motion vector information to the header information of the coded stream so that the predictive motion vector can be generated in the image decoding apparatus. The predictive motion vector information indicates which candidate has been selected as the predictive motion vector on the highest layer. Note that, as for the highest layer, the motion vector of a block on the highest layer can be coded and added to the coded stream instead of the coded data of the predictive motion vector information and the difference motion vector.

### <3. Operations of Image Coding Apparatus>

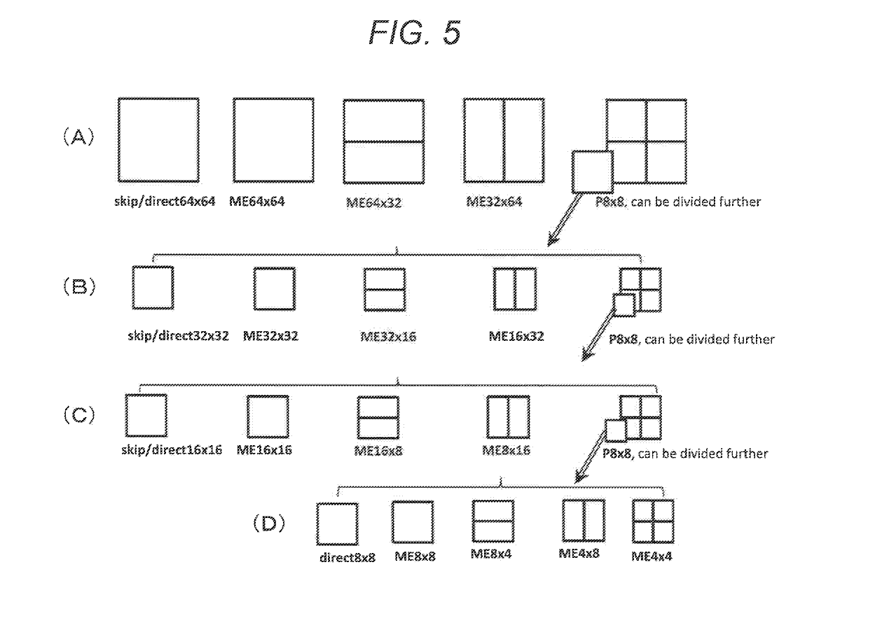

Next, the operations of the image coding process will be described. FIG. 5 shows the prediction block sizes used for the image coding process. In the H.264/AVC scheme, the prediction block sizes having 16×16 pixels to 4×4 pixels are defined for a macroblock having 16×16 pixels, as shown in FIGS. 5(C) and 5(D). When a macroblock more extended than that in the H.264/AVC scheme is used, for example, when a macroblock having 32×32 pixels is used, for example, the prediction block sizes shown in FIG. 5(B) are defined. Further, for example, when a macroblock having 64×64 pixels is used, for example, the prediction block sizes shown in FIG. 5(A) are defined.

Note that the “Skip/direct” shown in FIG. 5 indicates that the block size is the prediction block size when the skipped macroblock or the direct mode has been selected in the motion prediction/compensation unit 32. Further, the “ME” indicates the motion compensation block size. Further, the “P8×8” indicates that the block size can be divided, on a lower layer in which the macroblock size is reduced.

In the image coding apparatus, for the coding of the motion vector, layering is performed according to the block sizes. Note that, for simplification, of description, the layering is described as the following example. The block size having 32×32 pixels is assumed as the highest layer (a first layer), and the blocks having 16×16 pixels are assumed as the blocks on the next lower layer (a second layer). The blocks having 16×16 pixels are obtained by dividing the block size having 32×32 pixels twice into right and left, and into up and down. Further, for example, the blocks having 8×8 pixels are assumed as the blocks on the next lower layer (a third layer). The blocks having 8×8 pixels are obtained by dividing the blocks size having 16×16 pixels twice into right and left, and into up and down. The blocks having 4×4 pixels are assumed as the blocks of the lowest layer (a fourth layer). The blocks having 4×4 pixels are obtained by dividing the blocks size having 8×8 pixels twice into right and left, and into up and down.

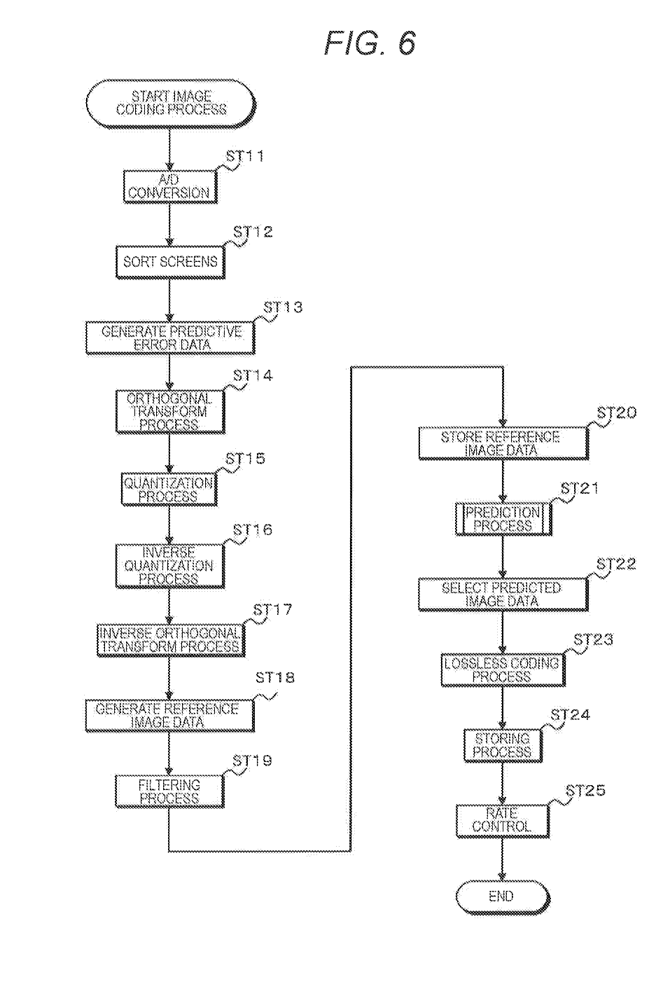

FIG. 6 is a flowchart for showing the operations of the image coding process. In step ST11, the A/D converting unit 11 performs an A/D conversion on the input image signal.

In step ST12, the screen sorting buffer 12 sorts the images. The screen sorting buffer 12 stores the image data supplied from the A/D converting unit 11 in order to sort the pictures from the order of display into the order for coding.

In step ST13, the subtraction unit 13 generates predictive error data. The subtraction unit 13 generates the predictive error data by calculating the difference between the image data sorted in step ST12 and the predicted image data selected in the predicted image/optimal mode selection unit 33. The predictive error data has a smaller data amount than that of the original image data. Thus, the data amount can be compressed in comparison with the case where the original image is coded without any change.

In step ST14, the orthogonal transform unit 14 performs an orthogonal transform process. The orthogonal transform unit 14 performs an orthogonal transform process on the predictive error data supplied from the subtraction unit 13. Concretely, the orthogonal transform such as the discrete cosine transform or the Karhunen-Loeve Transformation is performed on the predictive error data and the orthogonal transform unit 14 outputs the conversion coefficient data.

In step ST15, the quantization unit 15 performs a quantization process. The quantization unit 15 quantizes the conversion coefficient data. For the quantization, a rate control is performed as described at the process in step ST25 mentioned below.

In step ST16, the inverse quantization unit 21 performs an inverse quantization process. The inverse quantization unit 21 performs the inverse quantization on the conversion coefficient data using the characteristic corresponding to the characteristic of the quantization unit 15. The conversion coefficient data have been quantized, by the quantization unit 15.

In step ST17, the inverse orthogonal transform unit 22 performs an inverse orthogonal transform process. The inverse orthogonal transform unit 22 performs the inverse orthogonal transform on the conversion coefficient, data using the characteristic corresponding to the orthogonal transform unit 14. The conversion coefficient data have been subjected to the inverse quantization by the inverse quantization unit 21.

In step ST18, the addition unit 23 generates reference image data. The addition unit 23 generates the reference image data by adding the predicted image data supplied from the predicted image/optimal mode selection unit 33 to the data after the inverse orthogonal transform at the corresponding position to the reference image data.

In step ST19, the deblocking filter 24 performs a filtering process. The deblocking filter 24 filters the reference image data output from the addition unit 23 in order to eliminate the block distortion.

In step ST20, the frame memory 27 stores reference image data. The frame memory 27 stores the filtered reference image data.

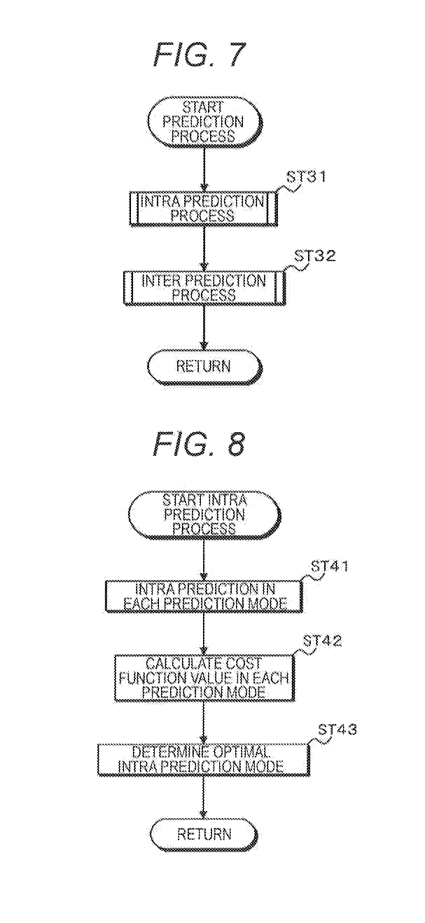

In step ST21, each of the intra prediction unit 31 and the motion prediction/compensation unit 32 performs a prediction process. In other words, the intra, prediction unit 31 performs an intra prediction process in the intra prediction mode. The motion prediction/compensation unit 32 performs a motion prediction and compensation process in the inter prediction mode. The detailed prediction processes will be described below with reference to FIG. 7. By the processes, the prediction process in each of all the candidate prediction modes is performed in order to calculate the cost function values in each of the candidate prediction modes. Then, the optimal intra prediction mode and the optimal inter prediction mode are selected based on the calculated cost function values. The predicted image that has been generated in the selected prediction modes, the cost function value of the predicted image, and the prediction mode information are supplied to the predicted image/optimal mode selection unit 33.

In step ST22, the predicted image/optimal mode selection unit 33 selects the predicted image data. The predicted image/optimal mode selection unit 33 determines the optimal mode causing the most efficient coding based on each, of the cost function values output from the intra prediction unit 31 and the motion prediction/compensation unit 32. The predicted image/optimal mode selection unit 33 further selects the predicted image data in the determined optimal mode and supplies the data to the subtraction unit 13 and the addition unit 23. The predicted image is used for the calculations in steps ST13 and ST18 as described above. Note that the prediction mode information corresponding to the selected predicted image data is output to the lossless coding unit 16.

In step ST23, the lossless coding unit 16 performs a lossless coding process. The lossless coding unit 16 losslessly codes the quantized data output from the quantization unit 15. In other words, a lossless coding such as the variable length coding or the Arithmetic coding is performed on the quantized data in order to compress the data. At that time, the prediction mode information that has been input to the lossless coding unit 16 in the above-mentioned step ST22 (and that includes, for example, the macroblock type, the prediction mode, the reference picture information and the like), the difference motion vector, and the like are also losslessly coded. Further, the losslessly-coded data such as the prediction mode information are added to the header information in the coded stream generated by the lossless coding of the quantized data.

In step ST24, the storage buffer 17 performs a storage process. The storage buffer 17 stores the coded stream output from the lossless coding unit 16. The coded stream stored in the storage buffer 17 is properly read and transmitted to the decoding side through a transmission channel.

In step ST25, the rate control unit 16 performs a rate control. The rate control unit 18 controls the rate of quantization operation in the quantization unit 15 to prevent the generation of an overflow or an underflow in the storage buffer 17 when the storage buffer 17 stores the coded steam.

Next, the prediction process in step ST21 shown in FIG. 6 will be described with reference to the flowchart of FIG. 7.

In step ST31, the intra prediction unit 31 performs an intra prediction process. The intra prediction unit 31 performs intra predictions on the image of the current block in all of the intra prediction modes. Note that the reference image data supplied from the addition unit 23 is used in the intra predictions. The detailed process of the intra prediction will be described below. By the process, the intra predictions are performed in all of the candidate intra prediction modes. The cost function values of all of the candidate intra prediction modes are calculated. Then, an intra prediction mode causing the most efficient coding is selected from among all of the intra prediction modes based on the calculated cost function values.

In step ST32, the motion prediction/compensation unit 32 performs an inter prediction process. The motion prediction/compensation unit 32 performs inter prediction processes in all the candidate inter prediction modes (at all of the prediction block sizes) using the filtered reference image data stored in the frame memory 27. The detailed process of the inter prediction will be described below. By the process, the inter prediction processes are performed in all of the candidate inter prediction modes. The cost function values of all of the candidate inter prediction modes are calculated. Then, an inter prediction mode causing the most efficient coding is selected from among all of the inter prediction modes based on the calculated cost function values.

Next, the intra prediction process in step ST31 shown in FIG. 7 will be described with reference to the flowchart of FIG. 8.

In step ST41, the intra prediction unit 31 performs the intra prediction in each of the prediction modes. The intra prediction, unit 31 generates predicted image data, in each of the prediction modes using the reference image data supplied from the addition unit 23.

In step ST42, the intra prediction unit 31 calculates the cost function value of each of the prediction modes. The cost function value is calculated based on either technique of the High Complexity mode or the Low Complexity mode as defined in the Joint Model (JM) that, is the reference software in the H.264/AVC scheme.

In other words, in the High Complexity mode, the operations to the lossless code are provisionally performed on all of the candidate prediction modes as the process in step ST42. Then, the cost function value of each of the prediction modes shown as the following expression (1) is calculated.

Cost(ModeεΩ)=D+λ·R (1)

The Ω denotes the universal set of the candidate prediction modes for coding the block to the macroblock. The D denotes the difference energy (distortion) between the reference image coded in the prediction mode and the input image. The R denotes the generated number of bits including the orthogonal transform coefficient and the prediction mode information. The λ denotes the Lagrange multiplier provided as the function of the quantization parameter QP.

In other words, the coding in the High Complexity Mode requires the larger amount of calculation because it is necessary to temporarily perform provisional encodes in all of the candidate prediction modes in order to calculate the above-mentioned parameters D and R.

On the other hand, in the Low Complexity mode, the operations to the generation of the predicted image and the calculation of the header bit that is the prediction mode information are performed on all of the candidate prediction modes as the process in step ST42. Then, the cost function value of each of the candidate prediction modes shown as the following expression (2) is calculated.

Cost(ModeεΩ)=D+QPtoQuant(QP)·Header_Bit (2)

The Ω denotes the universal set of the candidate prediction modes for coding the block to the macroblock. The D denotes the difference energy (distortion) between the reference image coded in the prediction, mode and the input image. The Header_Bit denotes the header bit of the prediction mode. The QPtoQuant denotes a function provided as the function of the quantization parameter QP.

In other words, in Low Complexity Mode, a decoded image is not required although it is not necessary to perform the prediction process in each of the prediction modes. Thus, the coding can be implemented with the lower amount of calculation than that in the High Complexity Mode.

In step ST43, the intra prediction unit 31 determines the optimal intra prediction mode. The intra prediction unit 31 selects an intra prediction mode having the minimum cost function value from among the cost function values calculated in step ST42 based on the cost function values, and determines the intra prediction mode as the optimal intra prediction mode.

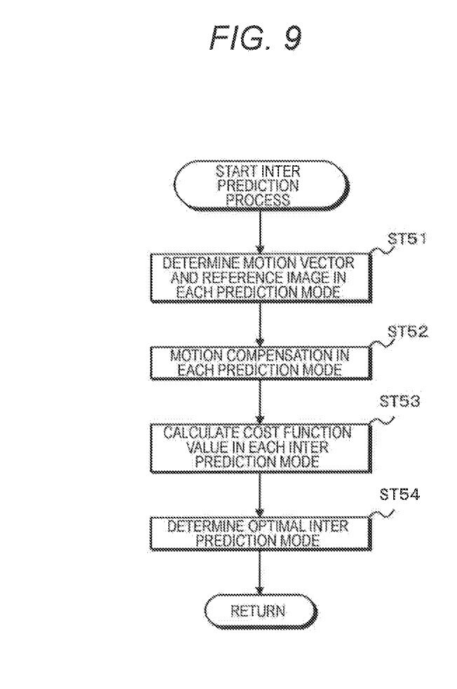

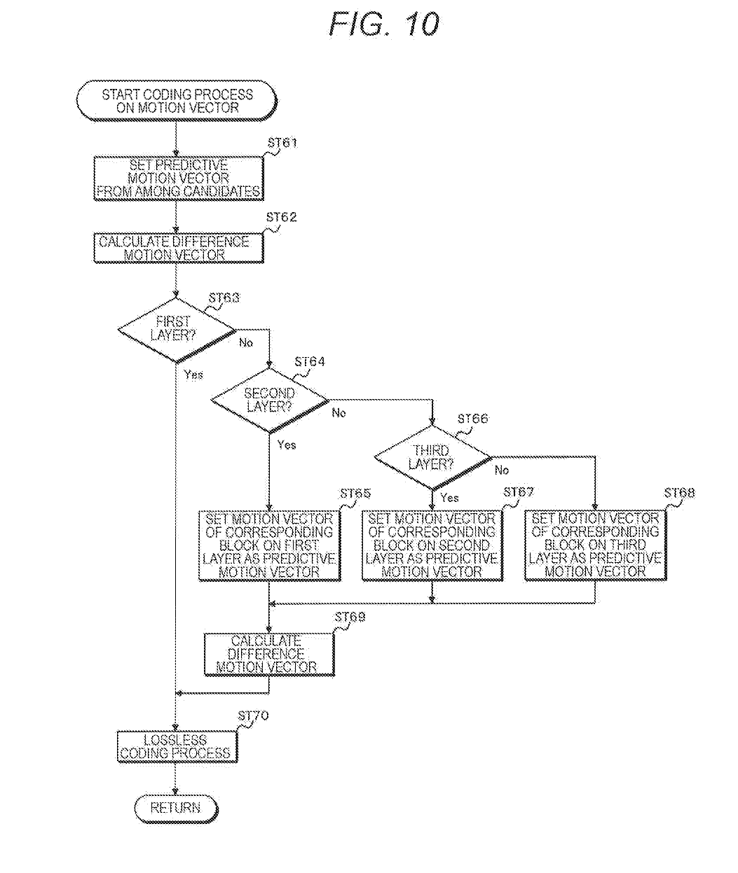

Next, the inter prediction process in step ST32 shown in FIG. 7 will be described with reference to the flowchart of FIG. 9.

In step ST51, the motion prediction/compensation unit 32 determines the motion vector and the reference image of each of the prediction modes. In other words, the motion prediction/compensation unit 32 determines the motion vector and the reference image of the current block in each of the prediction modes.

In step ST52, the motion prediction/compensation unit 32 performs a motion compensation of each of the prediction modes. The motion prediction/compensation unit 32 performs a motion compensation on the reference image in each of the prediction modes (at each of the prediction block sizes) based on the motion vector determined in step ST51 in order to generate the predicted image data of each of the prediction modes.

In step ST53, the motion prediction/compensation unit 32 calculates the cost function value of each of the inter prediction modes. The motion prediction/compensation unit 32 calculates the cost function value using the above-mentioned expression (1) or (2). To calculate the cost function value, the generated number of bits including the coding information selected in the selecting unit 165 is used. Note that the calculation of the cost function, value of the inter prediction mode includes the evaluation of the cost function value in the Skip Mode and the Direct Mode defined in the H.264/AVC scheme.

In step ST54, the motion prediction/compensation unit 32 determines the optimal inter prediction mode. The motion prediction/compensation unit 32 selects an prediction mode having the minimum cost function value from among the cost, function values calculated in step ST53 based on the cost function values, and determines the prediction mode as the optimal inter prediction mode.

Next, the coding process relating to a motion vector in the lossless coding unit 16 will be described with reference to the flowchart of FIG. 10. Note that the largest block size in FIG. 5, for example, the size having 32×32 pixels is assumed as a first layer (the highest layer) in FIG. 10. It is also assumed that the size having 16×16 pixels is a second layer, the size having 8×8 pixels is a third layer, and the smallest block size, for example, the size having 4×4 pixels is a fourth layer (the lowest layer).

In step ST61, the lossless coding unit 16 sets the predictive motion vector of the block on the highest layer from among the candidates. The lossless coding unit 16 sets, as the predictive motion vector on the first layer, the motion vector having the smallest cost function value from among the candidates of the predictive motion vector or, namely, the motion vectors of the adjoining blocks MV_A, MV_B, MV_C, MV_co, and MV_0. Then, the process goes to step ST62.

In step ST62, the lossless coding unit 16 calculates the difference motion vector of the block on the highest layer. The process goes to step ST63.

In step ST63, the lossless coding unit 16 determines whether the predictive block is on the first layer. When the predictive block in the optimal mode is on the first layer, the lossless coding unit 16 proceeds to step ST70. When the predictive block in the optimal mode is on a layer lower than the first layer, the lossless coding unit 16 proceeds to step ST64.

In step ST64, the lossless coding unit 16 determines whether the predictive block is on the second layer. When the predictive block is on the second layer, the lossless coding unit 16 proceeds to step ST65. When the predictive block in the optimal mode is on a layer lower than the second layer, the lossless coding unit 16 proceeds to step ST66.

In step ST65, the lossless coding unit 16 sets the motion vector of the corresponding block on the first layer as the predictive motion vector, and proceeds to step ST69.

In step ST66, the lossless coding unit 16 determines whether the predictive block is on the third layer. When the predictive block is on the third, layer, the lossless coding unit 16 proceeds to step ST67. When the predictive block in the optimal mode is on a layer lower than the third layer or, namely, the lowest layer, the lossless coding unit 16 proceeds to step ST68.

In step ST67, the lossless coding unit 16 sets the motion vector of the corresponding block on the second layer as the predictive motion vector, and proceeds to step ST69.

In step ST67, the lossless coding unit 16 sets the motion vector of the corresponding block on the third layer as the predictive motion vector, and proceeds to step ST69.

In step ST69, the lossless coding unit 16 calculates a difference motion vector. The lossless coding unit 16 calculates the difference motion vector that indicates the difference between the motion vector of each of the blocks and the predictive motion vector, and proceeds to step ST70.

In step ST70, the lossless coding unit 16 performs a lossless coding process. The lossless coding unit 16 losslessly codes the difference motion vector using a VLC table or the arithmetic coding. In the lossless coding, the coding is performed, for example, using a VLC table provided at each layer. The lossless coding unit 16 further generates the hierarchical structure information described below.

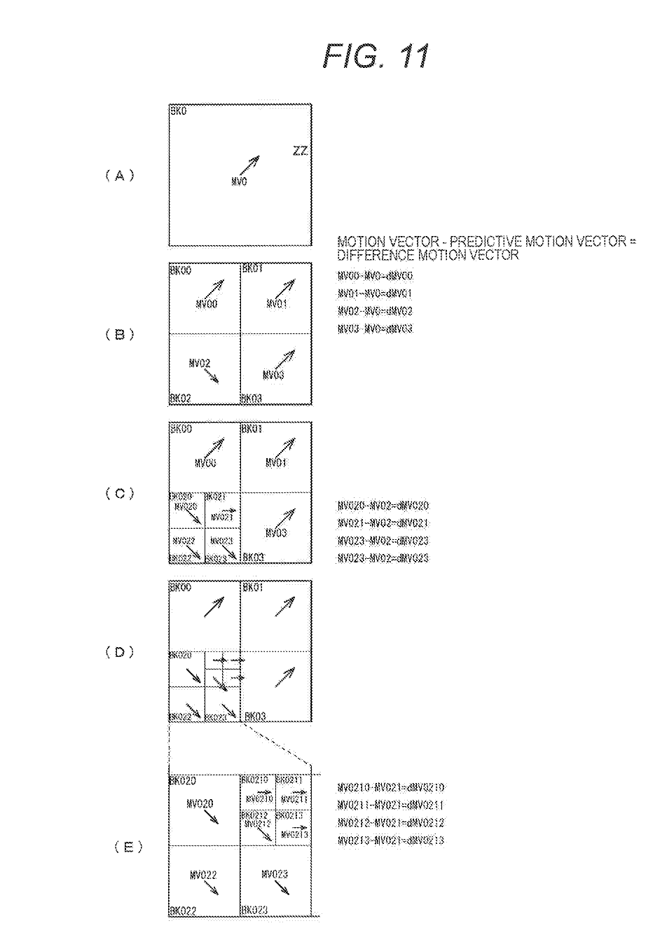

FIG. 11 shows exemplary operations when the coding process shown in FIG. 10 is performed. For example, as shown, in FIG. 11(A), when the predictive block is the block (macroblock) on the first layer that has the size of 32×32 pixels, the motion vector having the minimum cost function value is selected from among the motion vectors of the adjoining blocks as the predictive motion vector.

On the second layer shown in FIG. 11(B) and obtained by dividing the block BK0 on the first layer twice into right and left, and into up and down, the motion vector MV0 detected at the block BK0 on the first layer is set as the predictive motion vector. Accordingly, the difference motion vector dMV00 of the block BK00 on the second layer is expressed by “MV00−MV0=dMV00”. Similarly, on the second layer, the difference motion vector dMV01 of the block BK01 is expressed by “MV01−MV0=dMV01”, the difference motion vector dMV02 of the block BK02 is expressed by “MV02−MV0=dMV02”, and one difference motion vector dMV03 of the block BK03 is expressed by “MV03−MV0=dMV03”.

On the third layer shown in FIG. 11(C) and obtained by dividing the block on the second layer twice into right and left, and into up and down, the motion vector detected at the block on the second layer is set as the predictive motion vector. For example, at the block on the third layer obtained by dividing the block BK02 on the second layer twice into right and left, and into up and down, the motion vector MV02 detected at the block BK02 is set as the predictive motion vector. Accordingly, the difference motion vector dMV020 of the block BK020 on the third layer is expressed by “MV020−MV02=dMV020”. Similarly, on the third layer, the difference motion vector dMV021 of the block BK021 is expressed by “MV021−MV02=dMV021”, the difference motion vector dMV022 of the block BK022 is expressed by “MV022−MV02=dMV022”, and the difference motion vector dMV023 of the block BK023 is expressed by “MV023−MV02=dMV023”.

On the fourth layer shown in FIG. 11(D) and FIG. 11(E) and obtained by dividing the block on the third layer twice into right and left, and into up and down, the motion vector detected, at the block on the third layer is set as the predictive motion vector. For example, at the block on the fourth layer obtained, by dividing the block BK021 on the third layer twice into right and left, and into up and down, the motion vector MV021 detected at the block BK021 is set as the predictive motion vector. Accordingly, the difference motion vector dMV0210 of the block BK0210 on the third layer is expressed by “MV0210−MV021=dMV0210”. Similarly, at the fourth layer, the difference motion vector dMV0211 of the block BK0211 is expressed by “MV0211−MV021=dMV0211”, the difference motion vector dMV0212 of the block BK0212 is expressed, by “MV0212−MV021=dMV0212”, and the difference motion vector dMV0213 of the block BK0213 is expressed by “MV0213−MV021=dMV0213”.

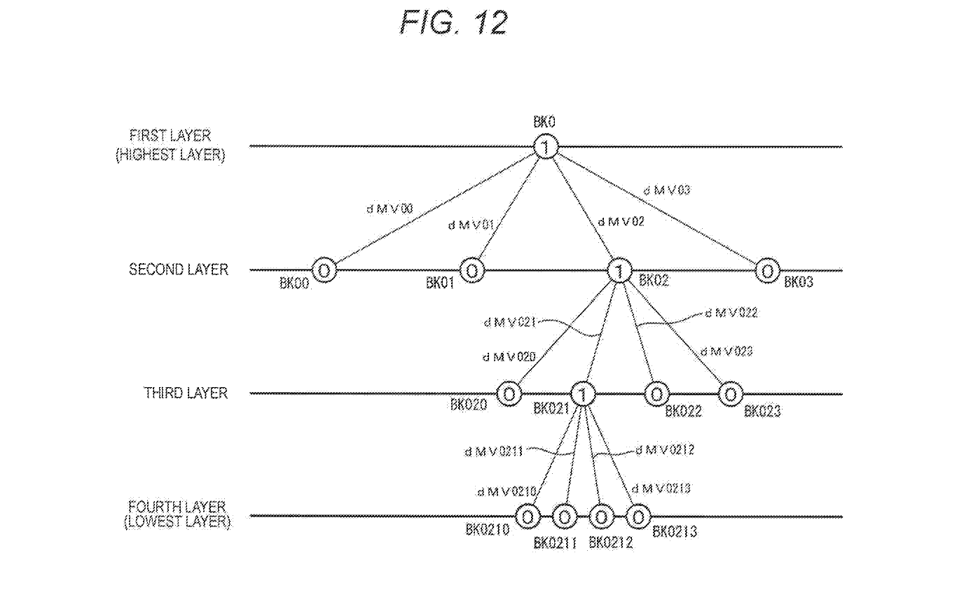

FIG. 12 is a view for describing hierarchical structure information. The hierarchical structure information generates information. When the block has a block at a lower layer obtained by dividing the block, the information is denoted as “1”. When the block does not have a block at a lower layer, the information is denoted as “0”.

For example, when blocks are layered as shown in FIGS. 11 and 12, the macroblock on the first layer has blocks on the lower layer. Thus, the information indicating the structure of the first layer is denoted as “1”. On the second layer, the lower left block has blocks on the lower layer. Accordingly, on the assumption, that the order of blocks is from upper left, upper right, lower left, to lower right, the information indicating the structure of the second layer is denoted as “0010”. On the third layer, the upper right block has blocks at the lower layer. Accordingly, on the assumption that the order of blocks is from upper left, upper right, lower left, to lower right, the information indicating the structure of the third layer is denoted as “0100”. Further, since the fourth layer does not have blocks at the lower layer, the information, indicating the structure of the fourth layer is denoted as “0000”. As described above, arranging the information obtained at each layer in the order of layers from highest to lowest can generate the hierarchical structure information “1001001000000” indicating the hierarchical structure shown in FIG. 12.

The lossless coding unit 16 losslessly codes the difference motion vector calculated at each layer and sets the obtained coded data as the order of blocks corresponding to the hierarchical structure information in order to include, to the stream information, the data together with the hierarchical structure information and the predictive motion vector selecting information on the highest layer. The lossless coding unit 16 further performs a lossless coding, for example, using a VLC table optimized at each layer.

As described above, according to the image coding apparatus and the image coding method of the present invention, the motion vector detected at a block on the next higher layer having a bigger block size is set as the predictive motion vector. Accordingly, a block on a lower layer obtained by dividing the block at the higher layer often has a smaller difference motion vector. This improves the efficiency of coding and can efficiently code an image. The reduced number of bits required to transmit a motion vector can increase the bit rate of the coded data, so that the image quality can be improved.

### <4. Structure of Image Decoding Apparatus>

Next, the decoding of the coded stream for generating a regeneration image data will be described. The coded stream generated in the image coding apparatus 10 is supplied to the image decoding apparatus through a predetermined transmission channel, a receding medium or the like in order to be decoded.

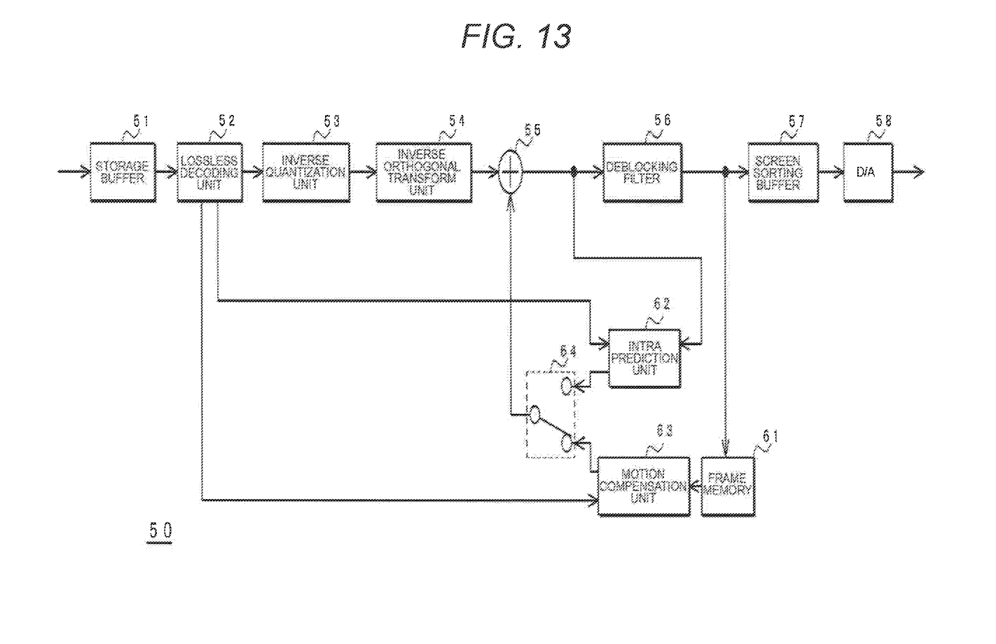

FIG. 13 shows the structure of an image decoding apparatus. An image decoding apparatus 50 includes a storage buffer 51, a lossless decoding unit 52, an inverse quantization unit 53, an inverse orthogonal transform unit 54, an addition unit 55, a deblocking filter 56, a screen sorting buffer 57, an digital/analog converting unit (D/A converting unit) 58. The image decoding apparatus 50 further includes a frame memory 61, an intra prediction unit 62, a motion compensation unit 63, and a selector 64.

The storage buffer 51 stores the transmitted coded stream. The lossless decoding unit 52 decodes the coded stream supplied from the storage buffer 51 in a corresponding scheme to the coding scheme by the lossless coding unit 16 shown in FIG. 2.

The lossless decoding unit 52 outputs the prediction mode information obtained by decoding the header information in the coded stream to the intra prediction unit 62, the motion compensation unit 63, and the deblocking filter 56. The lossless decoding unit 52 uses the motion vectors of the block to be decoded and of the decoded adjoining blocks in order to further set the candidates of the predictive motion vector. The lossless decoding unit 52 selects the predictive motion vector from among the candidates of the predictive motion vector based on the predictive motion vector selecting information obtained by losslessly decoding the coded stream in order to set the selected motion vector as the predictive motion vector on the highest layer. The lossless decoding unit 52 adds the predictive motion vector to the difference motion vector obtained by losslessly decoding the coded stream in order to calculate the motion, vector of the block to be decoded and further output the motion vector to the motion compensation unit 63. The lossless decoding unit 52 alternatively uses the motion, vector on the next higher layer as the predictive motion vector on a layer having a smaller size than that on the highest layer.

The inverse quantization unit 53 performs an inverse quantization of the quantized data decoded in the lossless decoding unit 52 in a corresponding scheme to the quantization scheme by the quantization unit 15 shown in FIG. 2. The inverse orthogonal transform unit 54 performs an orthogonal transform, of the output from the inverse quantization unit 53 in a corresponding scheme to the orthogonal transform scheme by the orthogonal transform unit 14 shown in FIG. 2 in order to output the output to the addition unit 55.

The addition unit 55 adds the data after the orthogonal transform to the predicted image data supplied from the selector 64 in order to generate decoded image data and output the decoded image data to the deblocking filter 56 and the intra prediction unit 62.

The deblocking filter 56 filters the decoded image data supplied from the addition unit 55 in order to eliminate the block distortion. Then, the deblocking filter 56 supplies and stores the data into the frame memory 61 and outputs the data to the screen sorting buffer 57.

The screen sorting buffer 57 sorts the images. In other words, the frames that have been sorted by the screen sorting buffer 12 shown in FIG. 2 in the order for coding are sorted in the original order of display and are output to the D/A converting unit 58.

The D/A converting unit 58 performs a D/A conversion on the image data supplied, from, the screen sorting buffer 57 and outputs the image data to a display (not shown in the drawings) in order to display an image on the display.

The frame memory 61 maintains the filtered decoded image data supplied from the deblocking filter 24.

The intra prediction unit 62 generates a predicted image based on the prediction mode information supplied from the lossless decoding unit 52 in order to output the generated predicted, image data to the selector 64.

The motion compensation unit 63 performs a motion compensation based on the prediction mode information and the motion vector that have been supplied from the lossless decoding unit 52 in order to generate a predicted image data and output the predicted image data to the selector 64. In other words, the motion compensation unit 63 performs a motion compensation of the reference image indicated by the reference image information using the motion vector based, on the motion vector and the reference frame information that have been supplied from the lossless decoding unit 52 in order to generate the predicted image data having the prediction block size.

The selector 64 supplies the predicted, image data generated in the intra prediction unit 62 to the addition unit 55. The selector 64 further supplies the predicted, image data generated in the motion compensation, unit 63 to the addition unit 55.

### <5. Structure of Lossless Decoding Unit>

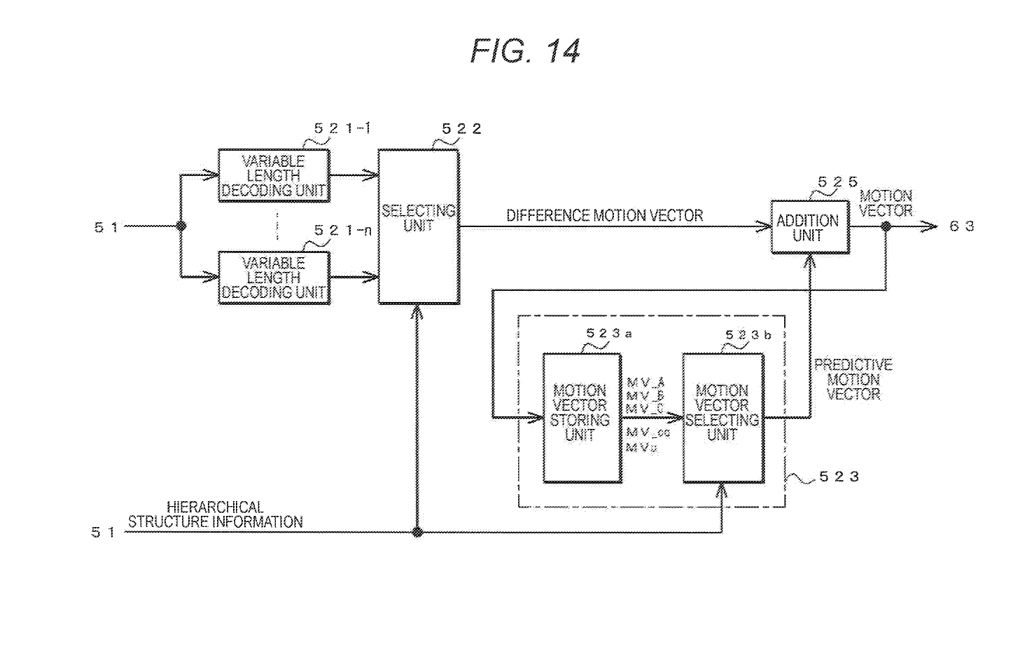

FIG. 14 shows the structure relating to a motion vector in a lossless decoding unit. The lossless decoding unit 52 includes variable length decoding units 521-1 to 521-n, a selecting unit 522, a predictive motion vector setting unit 523, and an addition unit 525. The predictive motion vector setting unit 523 includes a motion vector storing unit 523a and a motion vector selecting unit 523b.

The variable length decoding unit 521-1 performs a variable length decoding corresponding to the coding performed in the variable length coding unit 164-1. Similarly, the variable length decoding units 521-2 to 521-n perform variable length decoding corresponding to the coding performed, in the variable length coding units 164-2 to 164-n. The variable length decoding units 521-1 to 521-n perform lossless variable length decoding of coded streams using a VLC table or the arithmetic coding in order to generate difference motion vectors.

The selecting unit 522 selects a difference motion vector output from the decoding unit corresponding to the layer based on the hierarchical, structure information in order to output, the difference motion vector to the addition, unit 525.

On the highest layer in the maximum, prediction block size, the motion vector storing unit 523a stores the motion vectors of the decoded blocks adjoining to the block to be decoded in the maximum prediction block size as the candidates of the predictive motion vector on the highest layer. Note that the motion vector storing unit 523a can also store the motion vector of the block identical to the block to be decoded in the reference picture in order to respond to the direct mode. The motion vector storing unit 523a further stores the motion vector on a high layer including the block to be decoded.

The motion vector selecting unit 523b reads, from the motion vector storing unit 523a, the predictive motion vector according to the layer based on the hierarchical structure information in order to output the predictive motion vector to the addition unit 525. The motion vector selecting unit 523b further selects a motion vector from, among the candidates of the predictive motion vector based on the predictive motion vector information in order to output the motion vector as the predictive motion vector for the block on the highest layer to the addition unit 525.

The addition, unit 525 adds the predictive motion vector output from the predictive motion vector setting unit 523 to the difference motion vector selected in the selecting unit 522 in order to calculate the motion, vector of the block to be decoded and output the motion vector to the motion compensation unit 63. The addition unit 525 also stores the calculated motion vector in the motion vector storing unit 523a so that the motion vector can be used as the predictive motion vector for a lower layer. Note that, when the coded stream includes the coded data indicating the motion vector of a block on the highest layer, the addition unit 525 stores the motion, vector obtained by the variable length decoding in the motion vector storing unit 523a so that the motion vector can be used as the predictive motion vector on the lower layer.

### <6. Operations of Image Decoding Apparatus>

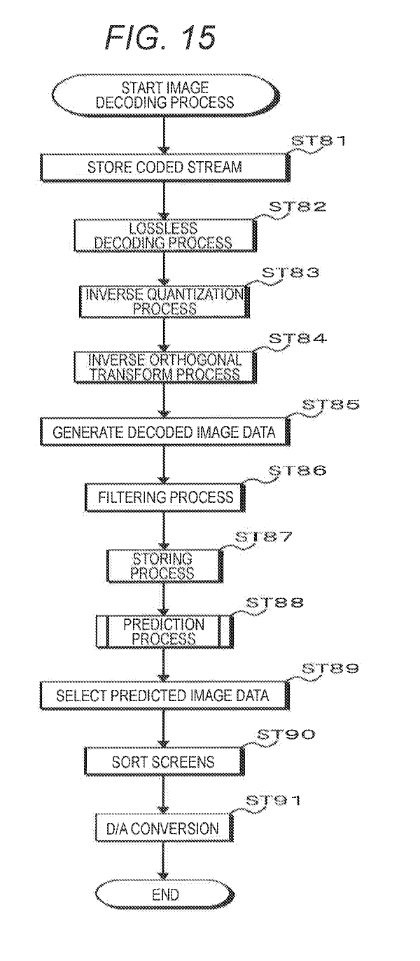

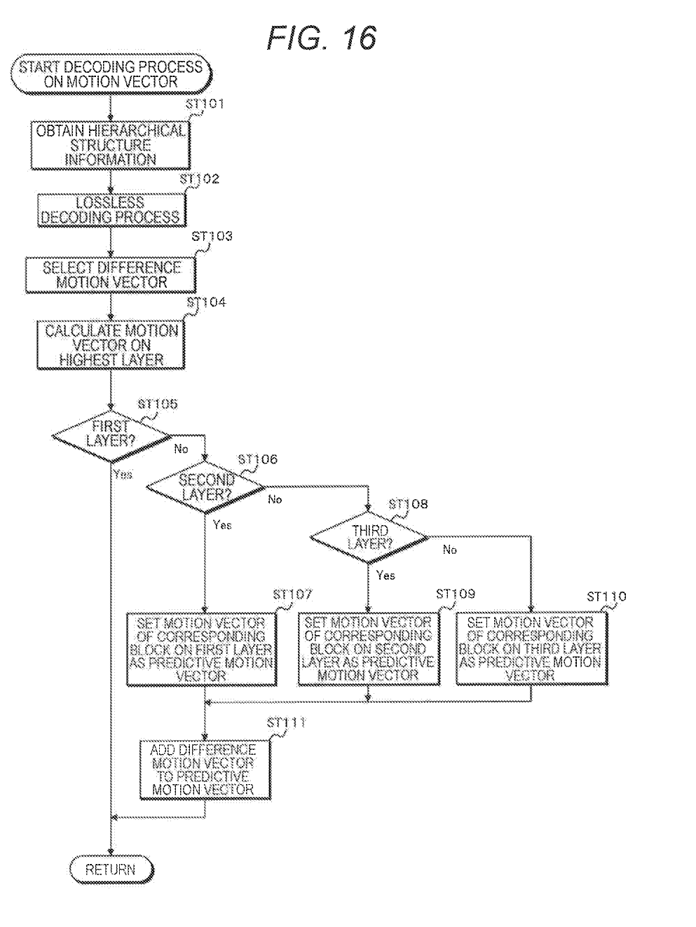

Next, the operations of the image decoding process performed in the image decoding apparatus 50 will be described with reference to the flowchart shown in FIG. 15.

In step ST81, the storage buffer 51 stores the transmitted coded stream. In step ST82, the lossless decoding unit 52 performs a lossless decoding process. The lossless decoding unit 52 decodes the coded stream supplied from the storage buffer 51. In other words, the quantized data of each picture that has been, coded by the lossless coding unit 16 shown in FIG. 2 are obtained. The lossless decoding unit 52 losslessly decodes the prediction mode information included, in the header information of the coded stream in order to supply the obtained, prediction, mode information to the deblocking filter 56 and the selector 64. When the prediction mode information is about the intra, prediction mode, the lossless decoding unit 52 further outputs the prediction mode information to the intra prediction unit 62. When the prediction mode information is about the inter prediction mode, the lossless decoding unit 52 alternatively outputs the prediction mode information to the motion compensation unit 63. The lossless decoding unit 52 further outputs the motion vector of the block to be decoded to the motion compensation unit 63.

In step ST83, the inverse quantization unit 53 performs an inverse quantization process. The inverse quantization unit 53 performs an inverse quantization of the quantized data using a characteristic corresponding to the characteristic of the quantization unit 15 shown in FIG. 2. The quantized data have been decoded by the lossless decoding unit 52.

In step ST84, the inverse orthogonal transform unit 54 performs an inverse orthogonal transform process. The inverse orthogonal transform unit 54 performs an inverse orthogonal, transform, of the conversion coefficient data using a characteristic corresponding to the characteristic of the orthogonal transform unit 14 shown in FIG. 2. The conversion coefficient data have been, subjected to the inverse quantization by the inverse quantization unit 53.

In step ST85, the addition unit 55 generates a decoded image data. The addition unit 55 adds the data obtained from the inverse orthogonal transform process to the predicted image data selected, in step ST89 described below in order to generate decoded image data. This decodes the original image.

In step ST86, the deblocking filter 56 performs a filtering process. The deblocking filter 56 filters the decoded image data output from the addition unit 55 in order to eliminate the block distortion included in the decoded image.

In step ST87, the frame memory 61 stores the decoded image data.

In step ST88, each of the intra prediction unit 62 and the motion compensation unit 63 performs a prediction process. Either the intra prediction unit 62 or the motion compensation unit 63 performs a prediction process according to the prediction mode information supplied from the lossless decoding unit 52.

In other words, when the prediction mode information about the intra prediction is supplied from the lossless decoding unit 52, the intra prediction unit 62 performs an intra prediction process based on the prediction mode information in order to generate the predicted image data. Alternatively, when the prediction mode information about the inter prediction is supplied from the lossless decoding unit 52, the motion compensation unit 63 performs a motion compensation based on the prediction mode information in order to generate the predicted image data.

In step ST89, the selector 64 selects the predicted image data. In other words, the selector 64 selects the predicted image supplied, from, the intra prediction unit 62 and the predicted image data generated in the motion compensation unit 63 and then supplies the predicted image and the predicted image data to the addition unit 55 in order to add the predicted image and the predicted image data to the output of the inverse orthogonal transform, unit 54 in step ST85 described above.

In step ST90, the screen sorting buffer 57 sorts the images. In other words, the screen sorting buffer 57 sorts the frames that have been sorted by the screen sorting buffer 12 of the image coding apparatus 10 shown in FIG. 2 from the order for coding to the original order for display.

In step ST91, the D/A converting unit 58 performs a D/A conversion of the image data from the screen sorting buffer 57. The image is output to a display (not shown in the drawings) to be displayed on the display.

Next, the decoding process of a motion vector performed in the lossless decoding unit 52 will be described with reference to the flowchart shown in FIG. 16. In step ST101, the lossless decoding unit 52 obtains the hierarchical structure information. The lossless decoding unit 52 obtains the hierarchical structure information from the storage buffer 51 in order to determine how the blocks of the layers form the block having a block size on the first layer.

In step ST102, the lossless decoding unit 52 corresponds to the lossless coding unit 16 to perform lossless decoding processes using a plurality of VLC tables or the like corresponding to the image coding apparatus in order to generate the difference motion vectors.

In step ST103, the lossless decoding unit 52 selects a difference motion vector. The lossless decoding unit 52 selects the difference motion vector corresponding to the layer including the block to be decoded from among the difference motion vectors generated using the VLC tables or the like.

In step ST104, the lossless decoding unit 52 calculates the motion vector on the highest layer. The lossless decoding unit 52 sets the predictive motion vector from among the candidates of the predictive motion vector for the highest layer based on the predictive motion vector selecting information included in the coded stream. The lossless decoding unit 52 further adds the set predictive motion vector to the difference motion vector on the highest layer in order to calculate the motion vector of the block on the highest layer, and the lossless decoding unit 52 proceeds to step ST105.

In step ST105, the lossless decoding unit 52 determines whether the block to be decoded is the block on the first layer. When the block to be decoded is the block on the first layer, the lossless decoding unit 52 terminates the decoding process of the motion vector of the block to be coded. When the block to be decoded, is not the block on the first layer, the lossless decoding unit 52 alternatively proceeds to step ST106. The lossless decoding unit 52 determines which layer includes the block to be decoded based on the hierarchical structure information. When the information about the structure of the first layer is denoted as “0” and indicates that the first layer is not divided, the lossless decoding unit 52 terminates the decoding process of the motion vector of the block to be coded. When the information about, the structure of the first layer is denoted as “1” and indicates that the first layer is divided, the lossless decoding unit 52 proceeds to step ST106.

In step ST106, the lossless decoding unit 52 determines whether the block to be decoded is the block on the second layer. When the block to be decoded is the block on the second layer, the lossless decoding unit 52 proceeds to step ST107. When the block to be decoded is not the block on the second layer, the lossless decoding unit 52 alternatively proceeds to step ST108. When the information about the structure of the second layer is denoted as “0” and indicates that the second layer is not divided, the lossless decoding unit 52 proceeds to step ST107. When the information about the structure of the second layer is denoted as “1” and indicates that the second layer is divided, the lossless decoding unit 52 alternatively proceeds to step ST108.

In step ST107, the lossless decoding unit 52 sets the motion vector of the corresponding block on the first layer as the predictive motion vector, and proceeds to step ST111.

In step ST108, the lossless decoding unit 52 determines whether the block to be decoded is the block on the third layer. When the block to be decoded is the block on the third layer, the lossless decoding unit 52 proceeds to step ST109. When the block to be decoded is not the block on the second layer, the lossless decoding unit 52 alternatively proceeds to step ST110. When the information about the structure of the third layer is denoted as “0” and indicates that the third layer is not divided, the lossless decoding unit 52 proceeds to step ST109. When the information about the structure of the third layer is denoted as “1” and indicates that the third layer is divided, the lossless decoding unit 52 alternatively proceeds to step ST110.

In step ST109, the lossless decoding unit 52 sets the motion vector of the corresponding block on the second layer as the predictive motion vector, and proceeds to step ST111.

In step ST110, the lossless decoding unit 52 sets the motion vector of the corresponding block on the third layer as the predictive motion vector, and proceeds to step ST111.

In step ST111, the lossless decoding unit 52 adds the difference motion vector to the predictive motion vector in order to calculate the motion vector of the block to be decoded.

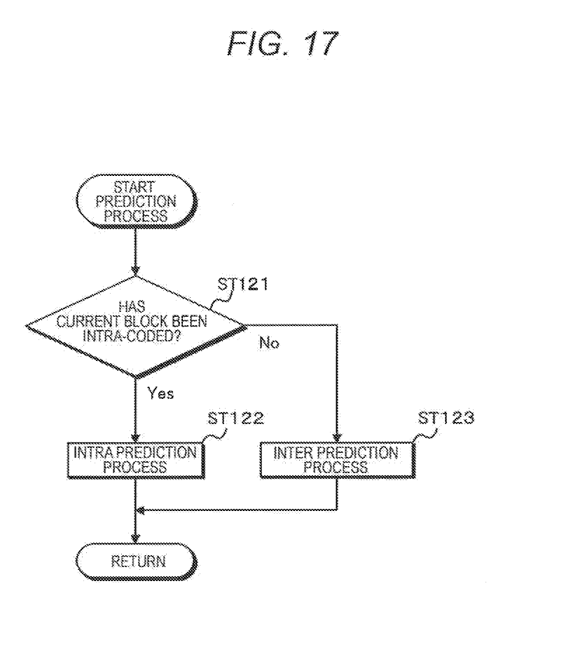

Next, the prediction process in step ST88 shown in FIG. 15 will be described with reference to the flowchart shown in FIG. 17.

In step ST121, the lossless decoding unit 52 determined whether the current block has been infra-coded. When the prediction mode information obtained by performing the lossless decoding is the intra prediction mode information, the lossless decoding unit 52 supplies the prediction mode information to the intra prediction unit 62, and proceeds to step ST122. When the prediction mode information is not the intra prediction mode information, the lossless decoding unit 52 supplies the prediction mode information to the motion compensation unit 63, and proceeds to step ST123.

In step ST122, the intra prediction unit 62 performs an intra prediction process. The intra prediction unit 62 performs an intra prediction using the decoded image data supplied from the addition unit 55 and the prediction mode information, in order to generate the predicted image data.

In step ST123, the motion compensation unit 63 performs an inter prediction process. The motion compensation unit 63 performs the motion compensation of the decoded image data supplied from the frame memory 61 based on the prediction mode information and the motion vector from the lossless decoding unit 52. The motion compensation unit 63 further outputs the predicted image data generated by the motion compensation to the selector 64.

As described above, in the image decoding apparatus and the image decoding method according to the present invention, during the image coding, the motion vector detected at the block on a higher layer is set as the predictive motion vector. Thus, a coded stream can accurately be decoded even if the efficiency of coding and the image quality have been improved.

### <7. Another Structure of Image Coding Apparatus>

Next, another structure of the image coding apparatus will be described. When the motion vector is calculated by comparing the image including the block to be coded to the reference image during the image coding, it is necessary to read the image data of the reference image from the frame memory. Further, a dynamic random access memory (DRAM) is often used as the frame memory because the image data of the reference image has a large data amount. However, while the DRAM has a large capacity, the DRAM causes a significant delay in reading or writing. There is a problem, in that the transfer rate becomes slow in discontinuous reading or writing. Thus, it takes time to calculate the motion vector.

In light of the foregoing, the other structure of the image coding apparatus performs a multi-resolution analysis of the image data of the reference image in order to store the multi-resolution analysis result, in a cache memory such as a static random access memory (SRAM). The other structure further generates a low-resolution image having a small data amount using the multi-resolution analysis result stored in the cache memory. The image coding apparatus performs a motion prediction using the low-resolution image in order to roughly detect the motion vector. The image coding apparatus further sets a selected region based, on the result from the rough detection of the motion vector in order to accurately detect the motion, vector using the high-resolution image in the selected region. Repeating such detections of a motion vector can detect the motion vector with a high degree of accuracy even if the data amount of the image data read from a memory is reduced.

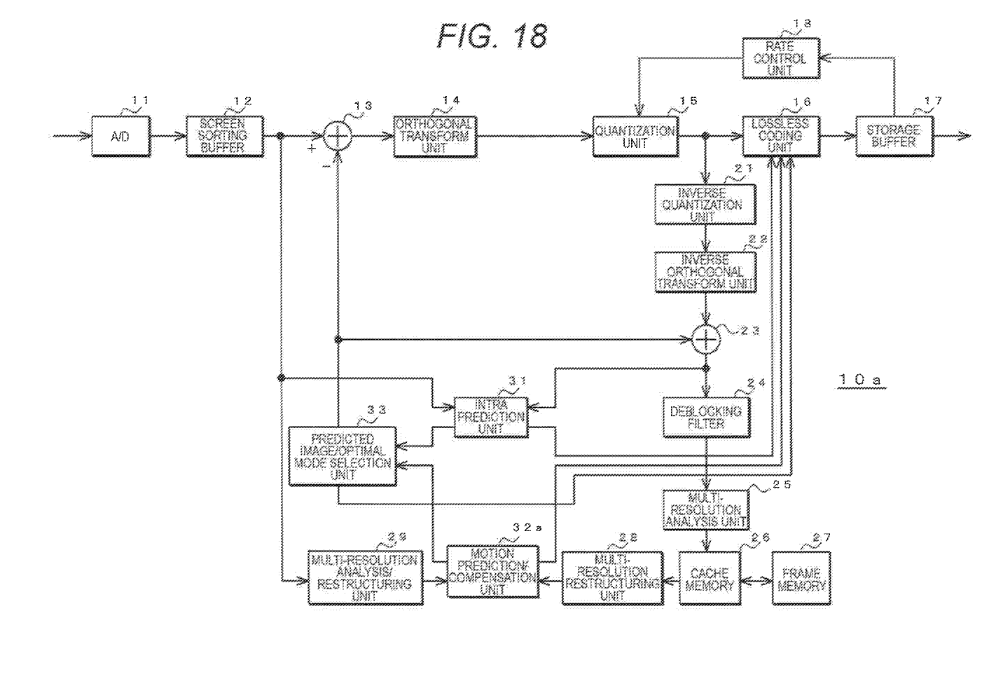

FIG. 18 shows the other structure of the image coding apparatus. Note that, in FIG. 18, the parts corresponding to those in FIG. 2 are denoted with the same reference signs.

An image coding apparatus 10a includes an analog/digital converting unit (A/D converting unit) 11, a screen sorting buffer 12, a subtraction unit 13, an orthogonal transform unit 14, a quantization unit 15, a lossless coding unit 16, a storage buffer 17, and a rate control unit 18. The image coding apparatus 10a further includes an inverse quantization unit 21, an inverse orthogonal transform unit 22, an addition unit 23, the deblocking filter 24, a multi-resolution analysis unit 25, a cache memory 26, a frame memory 27, a multi-resolution restructuring unit 28, and a multi-resolution analysis/restructuring unit 29. The image coding apparatus 10a further includes an intra prediction unit 31, a motion prediction/compensation unit 32a, and a predicted, image/optimal mode selection unit 33.

The A/D converting unit 11 converts analog image signals into digital image data in order to output the data to the screen sorting buffer 12.

The screen sorting buffer 12 sorts the frames of the image data output from the A/D converting unit 11. The screen sorting buffer 12 sorts the frames according to the group of pictures (GOP) structure relating to the coding process. The screen sorting buffer 12 outputs the sorted image data to the subtraction unit 13, the intra prediction unit 31, and the motion prediction/compensation unit 32a.

The subtraction unit 13 is supplied with the image data output from the screen sorting buffer 12 and with the predicted image data selected in the predicted image/optimal mode selection unit 33 described below. The subtraction unit 13 calculates the predictive error data and outputs the predictive error data to the orthogonal transform unit 14. The predictive error data is the difference between image data output from the screen sorting buffer 12 and the predicted image data supplied from the predicted image/optimal mode selection unit 33.

The orthogonal transform unit 14 performs an orthogonal transform on the predictive error data output from the subtraction unit 13 using the discrete cosine transform (DCT) or the Karhunen-Loeve Transformation. The orthogonal transform unit 14 outputs the conversion coefficient data obtained from the orthogonal transform process to the quantization unit 15.

The quantization unit 15 is supplied with the conversion coefficient data output from the orthogonal transform unit 14 and with a rate control signal from the rare control unit 18 described below. The quantization unit 15 quantizes one conversion coefficient data in order to output the quantized data to the lossless coding unit 16 and the inverse quantization unit 21. The quantization unit 15 further switches a quantization parameter (quantization scale) based on the rate control signal from the rate control unit IS in order to change the bit rate of the quantized data.

The lossless coding unit 16 is supplied with the quantized data output from the quantization unit 15 and with the predictive mode information from the intra prediction unit 31, the motion prediction/compensation unit 32a and the predicted image/optimal mode selection unit 33 described below. Note that the predictive mode information includes, for example, a macro-block type indicating the predictive block size, a predictive mode, reference picture information, depending on the intra prediction or the inter prediction. The lossless coding unit 16 codes the quantized data, for example, using the variable length coding or the arithmetic coding, in order to generate a coded stream and output the stream to the storage buffer 17. The lossless coding unit 16 further losslessly codes the predictive mode information in order to add the information, for example, to the header information of the coded stream. The lossless coding unit 16 further sets, as the predictive motion vector of the predictive block in the optimal mode that is the block of the image to be coded, the motion vector detected at the block on the next higher layer. The block includes the predictive block. The lossless coding unit 16 losslessly codes the difference motion vector indicating the difference between the predictive motion vector and the motion vector of the block to be coded, in order to add the difference motion vector to the coded stream. The lossless coding unit 16 further sets a predictive motion vector at each of the predictive blocks in the calculation of the cost function value described below and losslessly codes the difference motion vector indicating the difference from the motion vector of the predictive block so that the generated numbers of bits including the coded data of the difference motion vector can be calculated.

The storage buffer 17 stores the coded stream from the lossless coding unit 16. The storage buffer 17 further outputs the stored coded stream, at a transmission, rate according to the transmission channel.

The rate control unit 18 monitors the amount of space on the storage buffer 17 in order to generate a rate control signal according to the amount of space and output the signal to the quantization unit 15. The rate control unit 18, for example, obtains the information indicating the amount of space from the storage buffer 17. When the amount of space becomes small, the rate control, unit 18 reduces the bit rate of the quantized data using the rate control signal. On the other hand, when the amount of space on the storage buffer 17 is large enough, the rate control unit 18 increases the bit rate of the quantized data using the rate control signal.

The inverse quantization unit 21 performs an inverse quantization process on the quantized data supplied from the quantization unit 15. The inverse quantization unit 21 outputs, to the inverse orthogonal transform unit 22, the conversion coefficient data obtained from the inverse quantization process.

The inverse orthogonal transform unit 22 outputs, to the addition unit 23, the data obtained from the inverse orthogonal transform process on the conversion coefficient data supplied from the inverse quantization unit 21.

The addition unit 23 generates reference image data by adding the data supplied from the inverse orthogonal transform unit 22 to the predicted image data supplied from the predicted image/optimal mode selection unit 33 in order to output the reference image data to the deblocking filter 24 and the intra prediction unit 31.

The deblocking filter 24 performs a filtering process for reducing the block distortion developed when an image is coded. The deblocking filter 24 performs the filtering process for eliminating the block distortion from, the reference image data supplied from the addition unit 23 in order to output the filtered reference image data, to the multi-resolution analysis unit 25.

The multi-resolution analysis unit 25 performs a multi-resolution analysis of the reference image data, for example, a sub-band, decomposition using a discrete wavelet transform in order to output the multi-resolution analysis result to the cache memory 26. The multi-resolution analysis unit 25 performs a wavelet transform of an image, for example, using a 5/3 lossless filter.

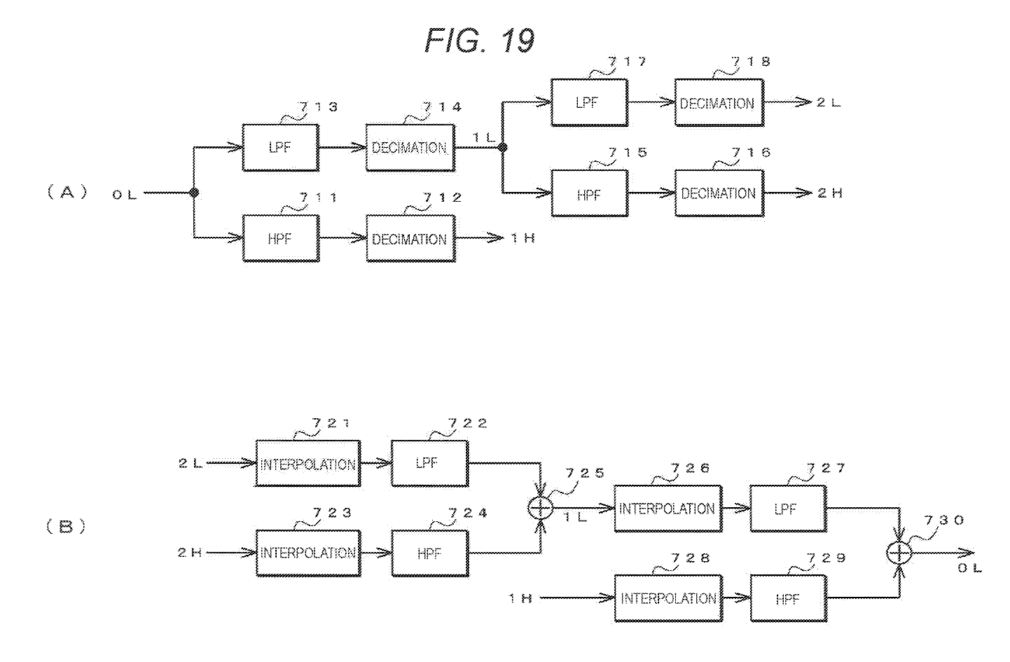

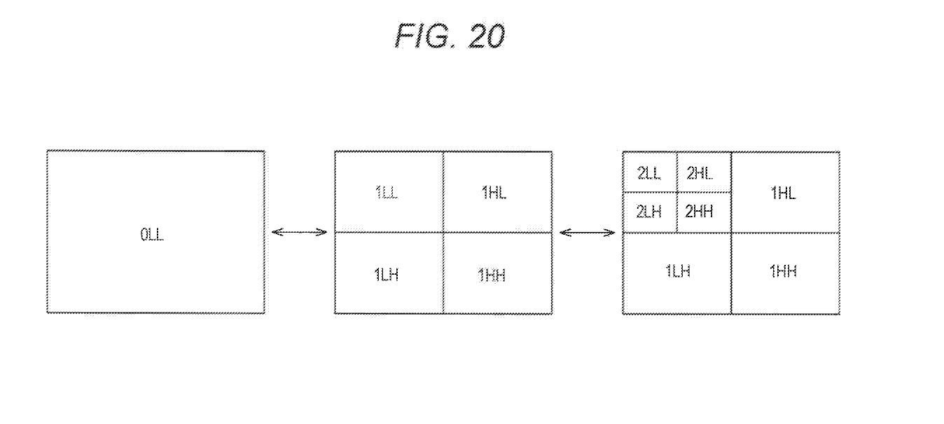

FIG. 19 is a view for describing the one dimensional sub-band decomposition and the restructuring. During the sub-band decomposition, as shown in FIG. 19(A), the image to be converted 0L is filtered by a high-pass filter (HPF) 711 and is decimated by a decimation unit (down sampler) 712 in order to generate a nigh-frequency component image 1H. The image to be converted 0L is further filtered by a low-pass filter (LPF) 713 and is decimated by a decimation unit 714 in order to generate a low-frequency component image 1L. The low-frequency component image 1L is further filtered by a high-pass filter 715 and is decimated by the decimation unit 716 in order to generate a high-frequency component image 2H. The low-frequency component image 1L is further filtered by a low-pass filter 717 and is decimated by the decimation unit 718 in order to generate a low-frequency component image 2L. As described above, the filtering processes and the decimation processes can generate images having different resolutions. Furthermore, when the processes shown in FIG. 19(A) are performed in a horizontal direction and in a vertical direction, the result from the two-dimensional sub-band decomposition is as shown in FIG. 20.

The cache memory 26 stores the multi-resolution analysis result in the order of resolution from lowest to highest. The cache memory further stores the amount of the multi-resolution analysis result exceeding the memory capacity in the frame memory 27.

The multi-resolution restructuring unit 28 reconstructs the reference images having different resolutions and outputs the image to the motion prediction/compensation unit 32a. The multi-resolution restructuring unit 28 performs an inverse wavelet transform, for example, using a 5/3 lossless filter. The multi-resolution restructuring unit 28 restructures an image by synthesizing the low-frequency component images and the high-frequency component images. During restructuring the image, as shown in FIG. 19(B), the low-frequency component image 2L is interpolated by an interpolation unit (up sampler) 721 and is filtered, by a low-pass filter 722, and the high-frequency component image 2H is interpolated by an interpolation unit 723 and is filtered by a high-pass filter 724, respectively. Furthermore, the filtered image is added in an addition unit 725 in order to generate a low-frequency component image 1L. The low-frequency component image 1L is further interpolated by an interpolation unit 726 and is filtered by a low-pass filter 727, and the high-frequency component image 1H is interpolated by an interpolation unit 728 and is filtered by a high-pass filter 729, respectively. Furthermore, the filtered image is added in an addition unit 730 in order to generate the image 0L before the sub-band decomposition. As described above, the interpolation processes and the filtering processes can restructure the image before the sub-band decomposition from the images having different resolutions. Furthermore, when the processes shown in FIG. 19(B) are performed in a horizontal direction and in a vertical direction, the images after the sub-band decomposition shown in FIG. 20 can be restored to the image before the division. For example, synthesizing images 2LL, 2HL, 2LH, and 2HH can generate an image 1LL shown in FIG. 20. Further, synthesizing images 1LL, 1HL, 1LH and 1HH can restructure an image 0LL.

The multi-resolution analysis/restructuring unit 29 performs, on an image to be coded, a multi-resolution analysis similarly to the multi-resolution analysis unit 25, for example, a discrete wavelet transform. The multi-resolution analysis/restructuring unit 29 further restructures the image selectively using the multi-resolution analysis result similarly to the multi-resolution restructuring unit 28 in order to generate images to be coded having different resolutions and output the images to the motion prediction/compensation unit 32a.

The intra prediction unit 31 performs the intra prediction processes in all candidate intra prediction modes using the image data of the image to be coded, output from the screen sorting buffer 12 and the reference image data supplied from the addition unit 23. The intra prediction unit 31 further calculates the cost function value of each of the intra prediction modes in order to select, as the optimal intra prediction mode, the intra prediction mode having the minimum calculated cost function value or, namely, the intra prediction mode causing the most efficient coding. The intra prediction unit 31 outputs, to the predicted image/optimal mode selection unit 33, the predicted image data generated in the optimal intra prediction mode, the prediction mode information about the optimal intra prediction mode, and the cost function value in the optimal intra prediction mode. In order to obtain the generated number of bits using for the calculation of the cost function value as described, below, the intra prediction unit 31 further outputs, to the lossless coding unit 16, the prediction mode information about the intra prediction mode during the intra prediction process in each of the intra prediction modes.

The motion predict ion/compensation unit 32a performs motion prediction and compensation processes using all the prediction block sizes (motion compensation block sizes) that correspond to a macroblock. Using the image data supplied from the multi-resolution restructuring unit 28 and the multi-resolution analysis/restructuring unit 29, the motion prediction/compensation unit 32a detects the motion vector of every image sit each prediction block size for the image of the macroblock read from the screen sorting buffer 12. The motion prediction/compensation unit 32a further performs a motion compensation process on the reference image based on the detected motion vector to generate a predicted image.

The motion prediction/compensation unit 32a further calculates the cost function value of each candidate of the predictive motion vector and notifies the value to the lossless coding unit 16. The motion prediction/compensation unit 32a selects the prediction, block size having the minimum cost function value or, namely, the prediction block size causing the most efficient coding as the optimal inter prediction mode based on the calculated cost function value of each of the prediction block sizes. The motion prediction/compensation unit 32a outputs, to the predicted image/optimal mode selection unit 33, the predicted image data generated in the optimal inter prediction mode, the prediction mode information about the optimal inter prediction mode, and the cost function value in the optimal inter prediction mode. The motion prediction/compensation unit 32a further outputs the prediction mode information about the inter prediction mode to the lossless coding unit 16 during the inter prediction process at each, of the prediction block sizes in order to obtain the generated numbers of bits that is used for the calculation of the cost function value. Note that the motion prediction/compensation unit 32a also predicts a skipped macroblock or a direct mode as the inter prediction mode.

The predicted image/optimal mode selection unit 33 compares the cost function value supplied from the intra prediction unit 31 to the cost function value supplied from the motion, prediction/compensation unit 32a by macroblock in order to select, the mode having the smaller cost function value as the optimal mode causing the most efficient coding. The predicted image/optimal mode selection unit 33 further outputs a predicted image data generated in the optimal mode to the subtraction unit 13 and the addition unit 23. The predicted image/optimal mode selection unit 33 further outputs the prediction mode information about the optimal mode to the lossless coding unit 16. Note that the predicted image/optimal mode selection unit 33 performs the intra prediction or the inter prediction by slice.

### <8. Operations for Detecting Motion Vector>

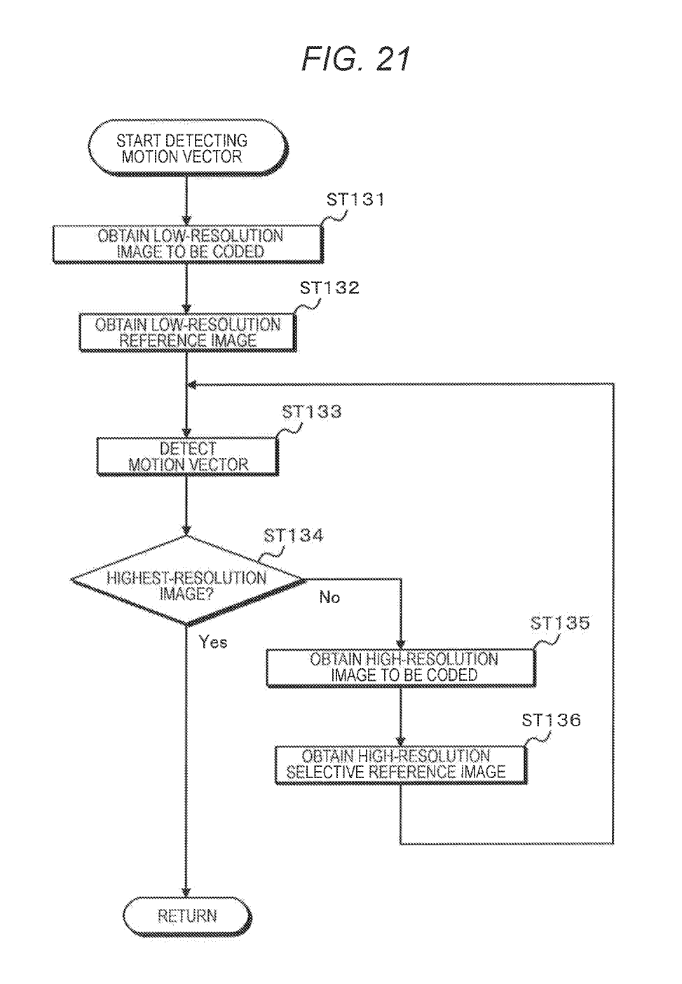

FIG. 21 is a flowchart for showing the operations for detecting a motion vector in the motion prediction/compensation unit 32a. Note that it is assumed that, the sub-band decomposition shown in FIG. 20 has been performed in the multi-resolution analysis.

In step ST131, the motion, prediction/compensation unit 32a obtains a low-resolution image to be coded. For example, the motion prediction/compensation unit 32a obtains, as the low-resolution image to be coded, an image having a block to be coded corresponding to the image 2LL that has the lowest resolution from the multi-resolution analysis/restructuring unit 29.

In step ST132, the motion prediction/compensation unit 32a obtains a low-resolution reference image. For example, the motion prediction/compensation unit 32a obtains a reference image of the image 2LL that corresponds to the block to be coded from the multi-resolution restructuring unit 28.

In step ST133, the motion prediction/compensation unit 32a detects a motion vector. The motion prediction/compensation unit 32a detects the motion vector of the block to be coded, for example, by performing a block matching between the image of the block to be coded and the reference image.

In step ST134, the motion prediction/compensation unit 32a determines whether the image that has been used for detecting the motion vector is the highest-resolution image. When the image that has been used for detecting the motion vector is the highest-resolution image, the motion prediction/compensation unit 32a terminates the operation for detecting the motion vector. Alternatively, when the image that has been used for detecting the motion vector is not the highest-resolution image, the motion prediction/compensation unit 32a proceeds to step ST135.

In step ST135, the motion prediction/compensation unit 32a obtains a high-resolution image to be coded. The motion prediction/compensation unit 32a obtains, from the multi-resolution analysis/restructuring unit 29, an image to be coded having a higher resolution than the image used in the previous detection of the motion vector. For example, when the image 2LL has been used in the previous detection of the motion vector, the motion prediction/compensation unit 32a obtains, as the high-resolution image to be coded, an image of a block to be coded corresponding to the image 1LL that has a higher resolution than the image 2LL.

In step ST136, the motion prediction/compensation unit 32a obtains a high-resolution selective reference image. The motion prediction/compensation unit 32a sets a selected region based on the motion vector detected in the previous detection oil the motion vector. The motion prediction/compensation unit 32a obtains, as the high-resolution selective reference image, the reference image in the selected region that has a higher resolution than the image used in the previous detection of the motion vector. For example, when the image 2LL has been used in the previous detection of the motion vector, the motion prediction/compensation unit 32a obtains, as the high-resolution selective reference image, the reference image in the selected region corresponding to the image 1LL that has a higher resolution than the image 2LL, and turns back to step ST133 in order to more accurately detect the motion vector using the high-resolution image.

The motion prediction/compensation unit 32a further obtains a higher-resolution image or, namely, an image 0LL of the block to be coded because the image 1LL is not one highest-resolution image. The motion prediction/compensation unit 32a further sets the selected region based on the motion vector detected using an image having the resolution of the image 1LL. The motion prediction/compensation unit 32a further obtains the reference image in the selected region that has a higher resolution than the image used in the previous detection of the motion vector. Using the obtained image can more accurately detect a motion vector.

As described above, performing the process shown in FIG. 21 can accurately detect a motion vector by obtaining the lowest-resolution image and restructuring the high-resolution image in the selected region selectively using the multi-resolution analysis result. Accordingly, a motion vector can be detected with a nigh degree of accuracy even if the data amount of the image data read from, a memory is reduced. This reduces the effects from the delay of data reading or the delay of transmission rate, so that an image can efficiently be coded.

The cache memory 26 further stores the multi-resolution analysis result in the order of resolution from, lowest to highest, and stores the multi-resolution analysis result exceeding the memory capacity in the frame memory 27. Accordingly, the lowest-resolution image can promptly be obtained and the high-resolution image in the selected region can promptly be restructured. This can accurately detect a motion vector.

<9. Process with Software>

A series of processes described herein can be implemented by hardware, software, or the combination of both. For implementing the process by software, a program receding the process sequence is installed on a memory incorporated in dedicated hardware in the computer and is executed. Alternatively, the program can be installed on a general-purpose computer capable of implementing various processes and be executed.

For example, the program can be recorded in a hard disc or a read only memory (ROM) used as a recording medium in advance. Alternatively, the program can temporarily or permanently be stored (recorded) in a removable recording medium such as a flexible disc, a compact disc read only memory (CD-ROM), a magneto optical (MO) disc, a digital versatile disc (DVD), a magnetic disc, or a semiconductor memory. Such a removable recording medium can be provided as so-called packaged software.

Note that the program can be not only installed on the computer from the removable recording medium as described above, but also received by the computer and installed on the embedded recording medium such as a hard disc by being wirelessly transmitted from a download site to the computer or being wired-transmitted to the computer through a network such as a local area network (LAN) or the Internet.

The step for describing the program includes not only the processes that are performed in time-series in the order of description but also the processes that are performed in parallel or individually, not necessarily in time-series.

### <10. Application to Electronic Device>

Although the H.264/AVC scheme is used as the coding scheme/the decoding scheme hereinabove, the present invention can be adopted to an image coding apparatus/an image decoding apparatus using a coding scheme/an decoding scheme performing another motion prediction and compensation process.

The present invention can further be adopted to an image coding apparatus and an image decoding apparatus used for receiving the image information (bit stream) through network media including satellite broadcasting, a cable television (TV), the Internet, and a mobile phone, or used for processing the image information on storage media including an optical or a magnetic disc, and a flash memory. The image information has been compressed by an orthogonal transform such as a discrete cosine transform and a motion compensation as MPEG, H.26x or the like.

The image coding apparatuses 10 and 10a, and the image decoding apparatus 50 described above can be adopted to a given electric device. The examples will be described below.

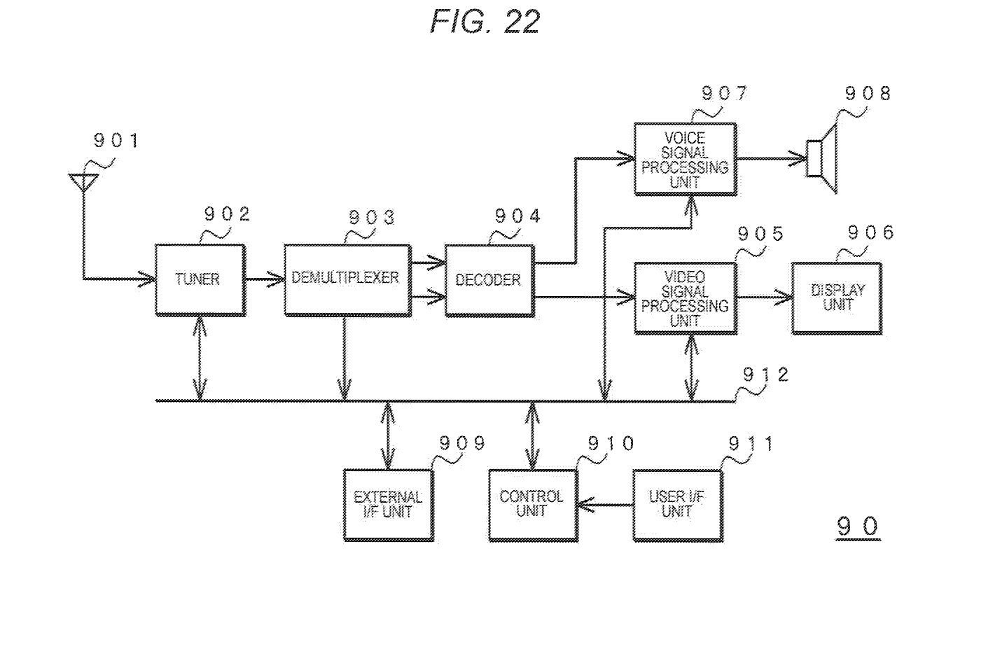

FIG. 22 is an exemplary view for showing a schematic structure of a television apparatus adopting the present invention. A television apparatus 90 includes an antenna 901, a tuner 902, a demultiplexer 903, a decoder 904, a video signal processing unit 905, a display unit 906, a voice signal processing unit 907, a loud speaker 908, and an external interface unit 909. The television apparatus 90 further includes a control unit 910, and a user interface unit 911.

The tuner 902 selects a desired channel from the broadcast wave signals received by the antenna 901 and demodulates the channel in order to output the obtained stream to the demultiplexer 903.

The demultiplexer 903 extracts the packets of the video and the voice of the program to be watched and listened, from the stream in order to output the data of the extracted packets to the decoder 904. The demultiplexer 903 further supplies the packet of the data, for example, of an electronic program guide (EPG) to the control unit 910. Note that, when the data is scrambled, the demultiplexer or the like decrypts the scrambled data.

The decoder 904 decodes the packet in order to output the video data generated by the decoding process to the video signal processing unit 905 and output the voice data to the voice signal processing unit 907.

The video signal processing unit 905 performs, on the video data, for example, a noise rejection or a video process depending on the user setting. The video signal processing unit 905 generates the video data of the program to be displayed on the display unit 906 or the image data by a process based on the application supplied through a network. The video signal processing unit 905 further generates the video data for displaying a menu screen or the like, for example, for selecting the items in order to superimpose the video data on the video data of the program. The video signal processing unit 905 generates a driving signal based on the video data generated in such a manner in order to drive the display unit 906.

The display unit 906 drives a display device (for example, a liquid crystal display element) based on the driving signal from the video signal processing unit 905 in order to display, for example, the video of the program.

The voice signal processing unit 907 performs a predetermined process such as a noise rejection on the voice data in order to perform a D/A conversion process or an amplification process on the processed voice data and supply the data to the loud speaker 908 in order to output the voice.

The external interface unit 909 is an interface for connecting to an external device or a network. The external interface unit 909 transmits/receives the data such as video data or voice data.

The control unit 910 is connected to the user interface unit 911. The user interface unit 911 includes an operating switch, and si remote control signal receiving part in order to supply an operating signal depending on the user operation to the control unit 910.

The control unit 910 includes a central processing unit (CPU) and a memory. The memory stores, for example, a program to be executed by the CPU, various data required for the CPU to perform a process, the EPG data, and the data obtained through a network. The program stored in the memory is read and executed by the CPU at a predetermined timing, for example, when the television apparatus 90 is activated. The CPU executes the program in order to control each part so that the television apparatus 90 operates in response to the user operation.

Note that the television apparatus 90 includes a bus 912 for connecting the tuner 902, the demultiplexer 903, the video signal processing unit 905, the voice signal processing unit 907, and the external interface unit 909 to the control unit 910.

The television apparatus having the above-mentioned structure is provided with the function of the image decoding apparatus (image decoding method) of the present invention at the decoder 904. Accordingly, even when the broadcasting station side uses the function of the image coding apparatus of the present invention in order to improve the efficiency of coding or the image quality and then generates a coded stream, the coded stream can accurately be decoded on the television, apparatus.

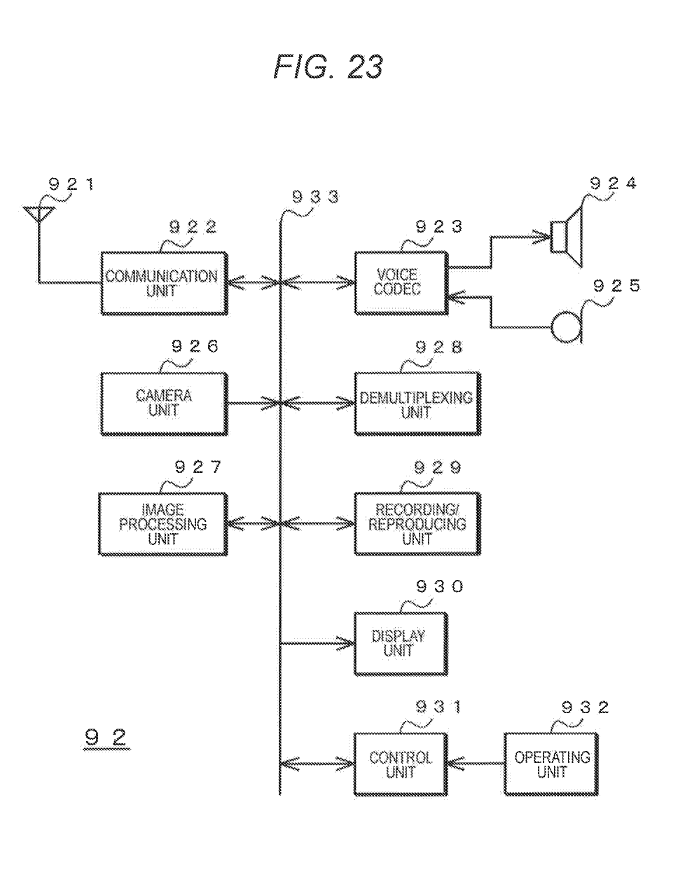

FIG. 23 is an exemplary view for showing a schematic structure of a mobile phone adopting the present invention. A mobile phone 92 includes a communication unit 922, a voice codec 923, a camera unit 926, an image processing unit 927, a demultiplexing unit 923, a recording/reproducing unit 929, a display unit 930, and a control unit 931. The units are connected to each other through a bus 933.

The communication unit 922 is connected to an antenna 921. The voice codec 923 is connected to a loud speaker 924, and a microphone 925. The control unit 931 is connected to an operating unit 932.

The mobile phone 92 performs various operations, for example, transmitting/receiving a voice signal, transmitting/receiving an e-mail or image data, taking an image, and recording data in various modes including a verbal communication mode, and data communication mode.

In the verbal communication mode, the voice signal generated at the microphone 925 is converted into voice data, and the data is compressed in the voice codec 923 and is supplied to the communication unit 922. The communication unit 922 modulates the voice data and converts the frequency in order to generate a transmission signal. The communication unit 922 further supplies the transmission signal to the antenna 921 in order to transmit the signal to a base station (not shown in the drawings). The communication unit 922 further amplifies the received signal received by the antenna 921, converts the frequency, and demodulates the signal in order to supply the obtained voice data to the voice codec 923. The voice codec 923 decompresses the voice data or converts the data, into an analog voice signal in order to output the signal to the loud speaker 924.

In the data communication mode, when an e-mail is transmitted, the control unit 931 receives the character data input by the operation of the operating unit 932 and displays the input character on the display unit 930. The control unit 931 further generates mail data, for example, based on the user instructions in the operating unit 932 and supplies the data to the communication unit 922. The communication unit 922 modulates the mail data and converts the frequency in order to transmit the obtained transmission signal from the antenna 921. The communication, unit 922 further, for example, amplifies the received signal received by the antenna 921, converts the frequency, and demodulates the signal in order to restore the e-mail data. The mail data is supplied, to the display unit 930 and the content of the mail is displayed.

Note that the mobile phone 92 can also store the received mail data in a storage medium using the recording/reproducing unit 929. The storage medium is a given rewritable storage medium. For example, the storage medium includes a semiconductor memory such as an RAM or a built-in flash memory, and a removable media including a hard disc, a magnetic disc, an optical magneto disc, an optical disc, a USB memory, or a memory card.

In the data communication mode, when image data are transmitted, the image data generated by the camera unit 926 are supplied to the image processing unit 921. The image processing unit 927 codes the image data in order to generate coded data.

The demultiplexing unit 928 multiplexes, in a predetermined scheme, the coded data generated in the image processing unit 927 and the voice data supplied from the voice codec 923 in order to supply the multiplexed data to the communication unit 922. The communication unit 922, for example, modulates the multiplexed data and converts the frequency in order to transmit the obtained transmission signal from the antenna 921. Further, the communication unit 922, for example, amplifies the received signal received by the antenna 921, converts the frequency and demodulates the signal in order to restore the multiplexed data. The multiplexed data is supplied to the demultiplexing unit 928. The demultiplexing unit 928 separates the multiplexed data in order to supply the coded data to the image processing unit 927 and supply the voice data to the voice codec 923.

The image processing unit 927 decodes the coded data in order to generate image data. The image data are supplied to the display unit 930, and the received image is displayed. The voice codec 923 converts the voice data into an analog voice signal and supplies the signal to the loud speaker 924 so that the received voice is output.

The mobile phone device having the above-mentioned structure is provided with the functions of the image coding apparatus (image coding method) and of the image decoding apparatus (image decoding method) of the present invention at the image processing unit 927. Accordingly, when the image data communication is performed, the efficiency of coding or the image quality can be improved.

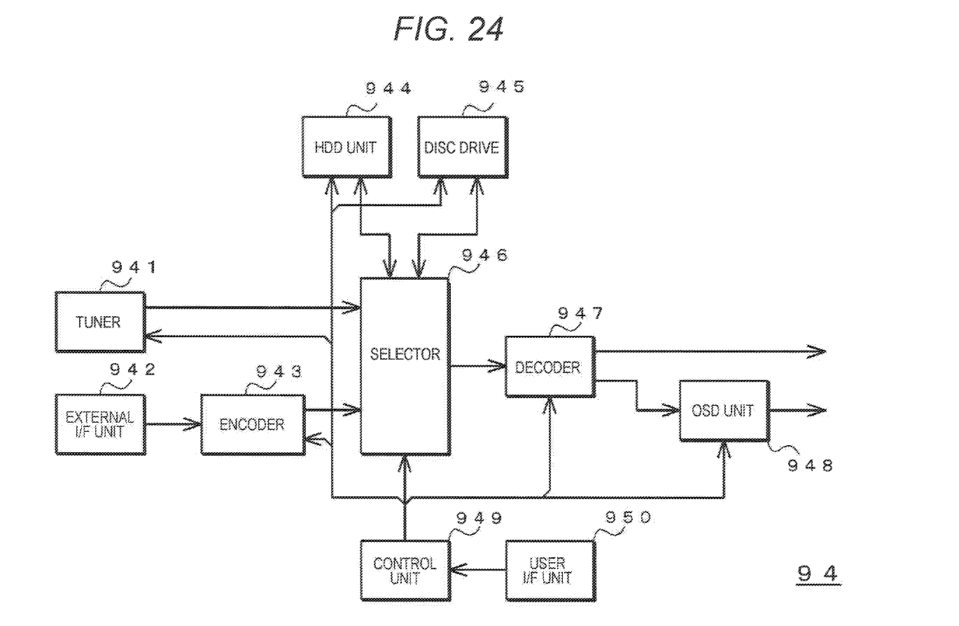

FIG. 24 is an exemplary view for showing a schematic structure of a record and replay apparatus adopting the present invention. A record and replay apparatus 94, for example, records the audio data and the video data of the received broadcast program in a recording medium and supplies the recorded data to the user at the timing depending on the user's instructions. The record and replay apparatus 94 can also, for example, obtain the audio data and the video data from another apparatus and record the data, in a recording medium. The record, and replay apparatus 94 further decodes and outputs the audio data and the video data that have been recorded in a recording medium so that a monitor device or the like can display an image or output a voice.

The record and replay apparatus 94 includes a tuner 941, an external, interface unit 942, an encoder 943, a hard disk drive (HDD) unit 944, a disc drive 945, a selector 946, a decoder 947, an on-screen display (OSD) unit 948, a control unit 949, and a user interface unit 950.

The tuner 941 selects a desired channel from the broadcast signals received by an antenna (not shown in the drawings). The tuner 941 demodulates the received signals of the desired channel in order to output the obtained coded stream to the selector 946.

The external interface unit 942 includes at least one of the IEEE1394 interface, a network interface unit, a USB interface, a flash memory interface, and the like. The external interface unit 942 is for connecting to an external device, a network, a memory card, or the like. The external interface unit 942 receives the data to be recorded such as the video data or the voice data.

When the video data and the voice data that have supplied from the external interface unit 942 are not coded, the encoder 943 codes the data in a predetermined scheme in order to output the coded stream to the selector 946.

The HDD unit 944 records contents data of a video, a voice or the like, various programs, another data, and the like in a built-in hard disc and, when the data are replayed, reads the data from the hard disc.

The disc drive 945 records and replays the signals for an attached optical disc. The optical disc, for example, includes a DVD disc (a DVD-Video, a DVD-RAM, a DVD-R, a DVD-RW, a DVD+R, a DVD+RW, or the like) and a Blu-ray disc.

When a video or a voice is recorded, the selector 946 selects a stream from either of the tuner 941 or the encoder 943 and supplies the stream to either of the HDD unit 944 or the disc drive 945. When a video or a voice is replayed, the selector 946 supplies the stream output from the HDD unit 944 or the disc drive 945 to the decoder 947.

The decoder 947 decodes the stream. The decoder 947 supplies the video data generated by the decoding process to the OSD unit 948. The decoder 947 also outputs the voice data generated by the decoding process.

The OSD unit 948 generates video data for displaying a menu screen or the like, for example, for selecting an item, and superimposes the data on the video data output from the decoder 947 in order to output the superimposed data.

The control unit 949 is connected to the user interface unit 950. The user interface unit 950 includes an operating switch, and a remote control signal receiving part in order to supply an operating signal depending on the user operation to the control unit 949.

The control unit 949 includes a CPU, a memory, and the like. The memory stores a program to be executed by the CPU, and various data required for the CPU to perform a process. The program stored in the memory is read and executed by the CPU at a predetermined timing, for example, when the record and replay apparatus 94 is activated. The CPU executes the program in order to control each, part so that the record and replay apparatus 94 operates in response to the user operation.

The record and replay apparatus having the above-mentioned structure is provided with the function of the image coding apparatus (image coding method) of the present invention at the encoder 943, and with, the function of the image decoding apparatus (image decoding method) of the present invention at the decoder 947. This improves the efficiency of coding or the image quality, and can efficiently record and replay a video.

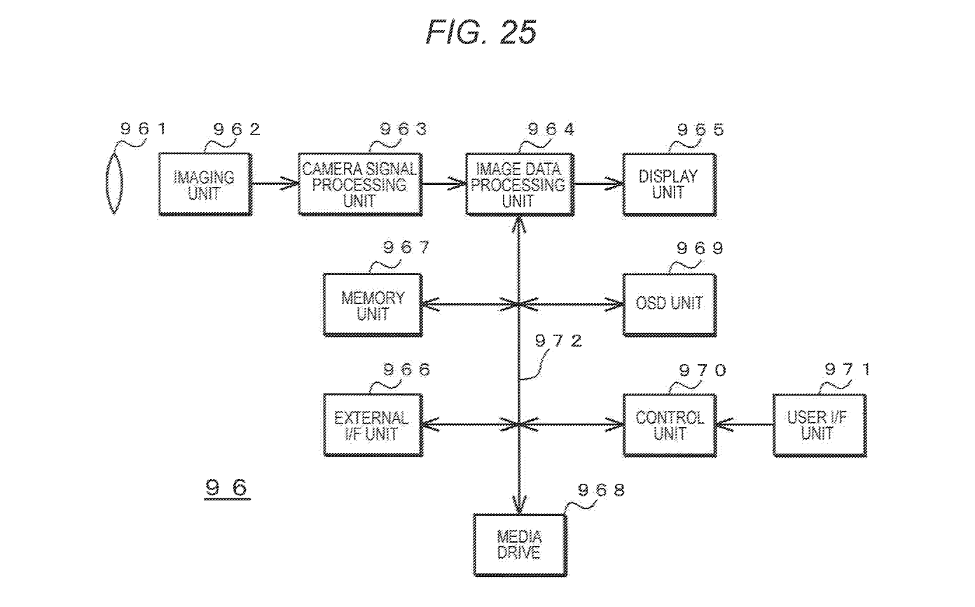

FIG. 25 is an exemplary view for showing a schematic structure of an imaging apparatus adopting the present invention. An imaging apparatus 96 takes an image of a subject, displays the image of the subject on the display unit, and records the image as image data in a recording medium.

The imaging apparatus 96 includes an optical block 961, an imaging unit 962, a camera signal processing unit 963, an image data processing unit 964, a display unit 965, an external interface unit 966, a memory unit 967, a media drive 968, an OSD unit 969, and a control unit 970. The control unit 970 is connected to a user interface unit 971. Further, the image data processing unit 964, the external interface unit 966, the memory unit 967, the media drive 968, the OSD unit 969, the control unit 970, and the like are connected to each other through a bus 972.

The optical block 961 includes a focus lens, an aperture mechanism, and the like. The optical block 961 forms an optical image of a subject on the imaging surface of the imaging unit 962. The imaging unit 962 includes a CCD or a CMOS image sensor in order to generate an electric signal according to the optical image by a photoelectric conversion, and supply the signal to the camera signal processing unit 963.

The camera signal processing unit 963 performs various camera signal processes, for example, a knee correction, a gamma correction, and a color correction on the electric signal supplied from the imaging unit 962. The camera signal processing unit 963 supplies the image data after the camera signal process to the image data processing unit 964.

The image data processing unit 964 codes the image data supplied from, the camera signal processing unit 963. The image data processing unit 964 supplies the coded data generated by the coding process to the external interface unit 966 and the media drive 963. The image data processing unit 964 further decodes the coded data supplied from the external interface unit 966 and the media drive 968. The image data processing unit 964 supplies the image data generated, by the decoding process to the display unit 965. The image data processing unit 964 further supplies, to the display unit 965, the image data supplied from the camera signal processing unit 963. The image data processing unit 964 superimposes the data to be displayed that has been obtained, from, the OSD unit 969 on the image data and supplies the superimposed data to the display unit 965.

The OSD unit 969 generates the data to be displayed that includes a menu screen including a symbol, a character, or a graphic, and an icon in order to output the data to the image data processing unit 964.

The external interface unit 966 includes, for example, a USE input/output terminal and, when an image is printed, is connected to a printer. The external interface unit 966 is connected, to a drive as necessary, and is properly attached with removable media including a magnetic disc, and an optical disc in order to install a computer program read from the media as necessary. The external interface unit 966 further includes a network interface connected to a predetermined network such as a LAN or the Internet. For example, according to the instructions from the user interface unit 971, the control unit 970 reads coded data from the memory unit 987 and supplies the data from the external interface unit 966 to another apparatus connected through a network. The control unit 970 can also obtain, through the external interface unit 966, coded data or image data that are supplied from another apparatus through a network, and supply the data to the image data processing unit 964.

For example, given readable, writable, and removable media including a magnetic disc, an optical magneto disc, an optical disc, or a semiconductor memory are used as recording media driven in the media drive 968. The recording media can also include any types of removable media, and can be a tape device, a disc, and a memory card. Of course, the recording media can be a non-contact IC card.

The media drive 968 can include a non-portable recording medium, for example, a built-in hard disc drive or a solid state drive (SSD), while combining with recording media.

The control unit 970 includes a CPU, a memory, and the like. The memory stores a program to be executed by the CPU, and various data required for the CPU to perform a process. The program stored in the memory is read and executed by the CPU at a predetermined timing, for example, when the imaging apparatus 96 is activated. The CPU executes the program, in order to control each, part so that the imaging apparatus 96 operates in response to the user operation.

The imaging apparatus having the above-mentioned structure is provided with the functions of the image coding apparatus (image coding method) and of the image decoding apparatus (image decoding method) of the present invention at the image data processing unit 964. Accordingly, when the taken, image is recorded in the memory unit 967, recording media, or the like, the efficiency of coding or the image quality is improved. Thus, the taken image can efficiently be recorded and replayed.

Further, the present invention shall not be interrupted, within the limitations of the above-mentioned embodiments of the present invention. Because the embodiments of the present invention disclose the present invention as examples, it is obvious that a person with an ordinary skill in the art can modify or alter the embodiments without departing from the gist of the invention. In other words, to judge the gist of the present invention, the scope of claims should be taken in consideration.

### INDUSTRIAL APPLICABILITY

According to the image decoding apparatus, the image coding apparatus, the image decoding method, the image coding method, and the program of the present invention, the improvement of the prediction accuracy using the motion vector on a higher layer as the predictive motion vector can efficiently decode and code an image. As for the detection of a motion vector, the motion vector is roughly detected, using a low-resolution image to be coded and a low-resolution reference image. The low-resolution image to be coded has been generated by a multi-resolution analysis of the image including the block to be coded and the restructuring of the image. The low-resolution reference image has been restructured using the multi-resolution analysis result obtained from a multi-resolution analysis w of the reference image. Then, the motion vector is accurately detected using a high-resolution, image to be coded and a high-resolution selective reference image in the selected region that has been set using the rough detection result. Thus, the data amount read from the memory can be small in order to detect the motion vector, and the motion vector can efficiently be detected. This can efficiently code an image.

Accordingly, the present invention is suitable, for example, for an image decoding apparatus and an image coding apparatus used for transmitting and receiving the image information (bit stream) through network media including satellite broadcasting, a cable television (TV), the Internet, and a mobile phone, or used for processing the image information on storage media including an optical or a magnetic disc, and a flash memory. The image information has been obtained from the coding by block as MPEG, H.26x or the like.

### REFERENCE SIGNS LIST

10, 10a Image coding apparatus
11 A/D converting unit
12, 57 Screen sorting buffer
13, 166 Subtraction unit
14 Orthogonal transform unit
15 Quantization unit
16 Lossless coding unit
17, 51 Storage buffer
18 Rate control unit
21, 53 Inverse quantization unit
22, 54 Inverse orthogonal transform unit
23, 55, 525 Addition unit
24, 56 Deblocking filter
25 Multi-resolution analysis unit
26 Cache memory
27, 61 Frame memory
28 Multi-resolution restructuring unit
29 Multi-resolution analysis/restructuring unit
31, 62 Intra prediction unit
32, 32a Motion prediction/compensation unit
33 Predicted image/optimal mode selection unit
50 Image decoding apparatus
52 lossless decoding unit
58 D/A converting unit
62 Motion compensation unit
64, 946 Selector
90 Television apparatus
92 Mobile phone
94 Record and replay apparatus
96 Imaging apparatus
161, 523 Predictive motion, vector setting unit
161a, 523a Motion vector storing unit
161b, 523b Motion vector selecting unit
164-1 to 164-n Variable length coding units
165, 522 Selecting unit
166 Hierarchical structure information generating unit
521-1 to 521-n Variable length decoding units
901, 921 Antenna
902, 941 Tuner
903 Demultiplexer
904, 947 Decoder
905 Video signal processing unit
906 Display unit
907 Voice signal, processing unit
908 Loud speaker
909, 942, 966 External interface unit
910, 931, 949, 970 Control unit
911, 932, 971 User interface unit
912, 933, 972 Bus
922 Communication unit
923 Voice codec
924 Loud speaker
925 Microphone
926 Camera unit
927 Image processing unit
928 Demultiplexing unit
929 Recording/reproducing unit
930 Display unit
943 Encoder
944 HDD unit
945 Disc drive
948, 969 OSD unit
961 Optical block
962 Imaging unit
963 Camera signal processing unit
964 Image data processing unit
965 Display unit
967 Memory unit
968 Media drive

1. An image decoding apparatus comprising:
a variable length decoding unit for decoding a coded stream to output a difference motion vector;
a predictive motion vector setting unit for setting a motion vector of a block on a higher layer as a predictive motion vector of a block to be decoded, the block at the higher layer including the block to be decoded and having a block size larger than a block size of the block to be decoded; and
an addition unit for adding the difference motion vector to the predictive motion vector to calculate the motion vector of the block to be decoded.

2. The image decoding apparatus according to claim 1, further comprising:
a plurality of the variable length decoding units; and
a selecting unit for selecting a difference motion vector output from the variable length decoding unit,
wherein the variable length decoding units perform variable length decoding of the stream corresponding to variable length coding according to each different layer, and
the selecting unit selects an output from the variable length decoding unit corresponding to the layer of the block to be decoded based on hierarchical structure information indicating the layer of the block to be decoded.

3. An image decoding method comprising:
a variable length decoding step for decoding a coded stream to output a difference motion vector;
a predictive motion vector setting step for setting a motion vector of a block on a higher layer as a predictive motion vector of a block to be decoded, the block at the higher layer including the block to be decoded and having a block size larger than a block size of the block to be decoded; and
an addition step for adding the difference motion vector to the predictive motion vector to calculate the motion vector of the block to be decoded.

4. A program for causing a computer to execute image coding and for causing the computer to execute:
a variable length decoding procedure for decoding a coded stream to output a difference motion vector;
a predictive motion vector setting procedure for setting a motion vector of a block on a higher layer as a predictive motion vector of a block to be decoded, the block at the higher layer including the block to be decoded and having a block size larger than a block size of the block to be decoded; and
an addition procedure for adding the difference motion vector to the predictive motion vector to calculate the motion vector of the block to be decoded.

5. An image coding apparatus comprising:
a predictive motion vector setting unit for setting a motion vector detected at a block on a higher layer as a predictive motion vector of a block to be coded, the block at the higher layer including the block to be coded and having a block size larger than a block size of the block to be coded;
a difference calculation unit for calculating a difference between the motion vector of the block to be coded and the set predictive motion vector; and
a variable length coding unit for performing variable length coding of the difference motion vector.

6. The image coding apparatus according to claim 5, further comprising:
a hierarchical structure information generating unit for generating, at each macroblock having a block size of a highest layer, hierarchical structure information indicating a layer of a block to be coded included in the macroblock.

7. The image coding apparatus according to claim 6, further comprising;
a plurality of the variable length coding units; and
a selecting unit for selecting coded data output from the variable length coding units,
wherein the variable length coding units perform variable length coding of the difference motion vector, and the variable length coding has been optimized in order to cause most efficient coding at each different layer, and
the selecting unit selects an output from, the variable length coding unit corresponding to the layer of the block to be coded.

8. The image coding apparatus according to claim 6, wherein the predictive motion vector setting unit uses motion vectors of coded adjoining macroblocks as candidates of the predictive motion vector in order to select a motion vector causing most efficient coding from among the candidates, and set the motion vector as the predictive motion vector of the highest layer.

9. The image coding apparatus according to claim 5, further comprising:
a multi-resolution analysis/restructuring unit for performing a multi-resolution analysis on an image of the block to be coded and restructuring the image;
a multi-resolution analysis unit for performing a multi-resolution analysis on a reference image used, for calculating the motion vector;
a memory for storing a result from the multi-resolution, analysis on the reference image; and
a multi-resolution restructuring unit for restructuring an image using the result from the multi-resolution analysis stored in the memory,
wherein a motion prediction unit for detecting the motion vector roughly detects a motion vector using a low-resolution, image to be coded and a low-resolution reference image, the low-resolution image to be coded having been generated in the multi-resolution analysis/restructuring unit and the low-resolution reference image having been generated in the multi-resolution restructuring unit, and then the motion prediction unit accurately detects the motion vector using a high-resolution image to be coded and a high-resolution selective reference image, the high-resolution image to be coded having been generated in the multi-resolution analysis/restructuring unit, the high-resolution selective reference image being in a selected region set based on the roughly-detected motion vector and having been generated in the multi-resolution restructuring unit.

10. An image coding method comprising:
a predictive motion vector setting step for setting a motion vector detected at a block on a higher layer as a predictive motion vector of a block to be coded, the block at the higher layer including the block to be coded and having a block size larger than a block size of the block to be coded;
a difference calculation step for calculating a difference between the motion vector of the block to be coded and the set predictive motion vector; and
a variable length coding step for coding the difference motion vector.

11. A program for causing a computer to execute image coding and for causing the computer to execute:
a predictive motion vector setting procedure for setting a motion vector detected at a block on a higher layer as a predictive motion vector of a block to be coded, the block at the higher layer including the block to be coded and having a block size larger than a block size of the block to be coded;
a difference calculation procedure for calculating a difference between the motion vector of the block to be coded and the set predictive motion vector; and
a variable length coding procedure for coding the difference motion vector.

12. An image coding apparatus comprising:
a multi-resolution analysis/restructuring unit for performing a multi-resolution analysis on an image of a block to be coded and restructuring the image;
a multi-resolution analysis unit for performing a multi-resolution analysis on a reference image used for calculating the motion vector;
a memory for storing a result from the multi-resolution analysis on the reference image;
a multi-resolution restructuring unit for restructuring an image using the result from the multi-resolution analysis stored in the memory; and
a motion prediction unit for roughly detecting a motion vector using a low-resolution image to be coded and a low-resolution reference image, and accurately detecting the motion vector using a high-resolution image to be coded and a high-resolution selective reference image, the low-resolution image to be coded being generated in the multi-resolution analysis/restructuring unit, the low-resolution reference image being generated in the multi-resolution restructuring unit, the high-resolution image to be coded being generated in the multi-resolution analysis/restructuring unit, the high-resolution selective reference image being in a selected region set based on the roughly-detected motion vector, the high-resolution selective reference image being generated in the multi-resolution restructuring unit.

13. The image coding apparatus according to claim 12,
wherein the memory comprises a first memory and a second memory,
the first, memory scores a multi-resolution analysis result in ascending order of resolution, and stores a multi-resolution analysis result exceeding a memory capacity of the first memory in the second memory, and
the multi-resolution restructuring unit restructures an image using the multi-resolution analysis result stored in the first memory and, when a necessary multi-resolution analysis result is not stored in the first memory, reads the necessary multi-resolution analysis result from the second memory.

14. An image coding method comprising:
a multi-resolution analysis/restructuring step for performing a multi-resolution analysis and restructuring on an image of a block to be coded;
a multi-resolution analysis step for performing a multi-resolution analysis on a reference image used for calculating the motion vector;
a storing step for storing a result from the multi-resolution analysis in a memory;
a multi-resolution restructuring step for restructuring an image using the result from the multi-resolution, analysis stored in the memory; and
a motion, prediction, step for roughly detecting a motion vector using a low-resolution image to be coded and a low-resolution reference image, and accurately detecting the motion vector using a high-resolution image to be coded and a high-resolution selective reference image, the low-resolution image to be coded being generated in the multi-resolution analysis/restructuring unit, the low-resolution reference image being generated in the multi-resolution restructuring unit, the high-resolution image to be coded being generated in the multi-resolution analysis/restructuring unit, the high-resolution selective reference image being in a selected region set based on the roughly-detected motion vector and being generated in the multi-resolution restructuring unit.

15. A program for causing a computer to execute image coding and for causing the computer to execute:
a multi-resolution analysis/restructuring procedure for performing a multi-resolution analysis and restructuring on an image of a block to be coded;
a multi-resolution analysis procedure for performing a multi-resolution analysis on a reference image used for calculating the motion vector;
a storing procedure for storing a result from the multi-resolution analysis in a memory;
a multi-resolution restructuring procedure for restructuring an image using the result from the multi-resolution analysis stored in the memory; and
a motion prediction procedure for roughly detecting a motion vector using a low-resolution image to be coded and a low-resolution reference image, and accurately detecting the motion vector using a high-resolution image to be coded and a high-resolution selective reference image, the low-resolution image to be coded being generated in the multi-resolution analysis/restructuring unit, the low-resolution reference image being generated in the multi-resolution restructuring unit, the high-resolution image to be coded being generated in the multi-resolution analysis/restructuring unit, the high-resolution selective reference image being in a selected region set based on the roughly-detected motion vector and being generated in the multi-resolution restructuring unit.
